(19) United States
(12) Patent Application Publication
(10) Pub. No.: US 2020/0261781 A1
(43) Pub. Date: Aug. 20, 2020

(54) DEVICE AND METHOD FOR IMPROVING GOLF SKILLS

(71) Applicant: 2Skills, LLC, Byron, IL (US)

(72) Inventor: Thomas A. Muldowney, Byron, IL (US)

(21) Appl. No.: 16/648,229

(22) PCT Filed: Sep. 7, 2018
(86) PCT No.: PCT/US18/49997

§ 371 Date: Mar. 18, 2020

Related U.S. Application Data
(60) Provisional application No. 62/555,585, filed on Sep. 7, 2017.

(51) Int. Cl. A63B 67/02; A63B 69/36; A63B 71/06

(52) U.S. Cl. CPC A63B 67/02; A63B 69/3661; A63B 71/0669; A63B 71/0622; A63B 2067/025; A63B 2071/0658; G07F 17/3288; A63B 2207/02; A63B 2209/08; A63B 2209/10; A63B 2210/50; A63B 2225/20; A63B 2225/50; A63B 2071/0694

(57) ABSTRACT

The present disclosure provides sports training devices for improving a user's technique. In some embodiments, the sports training device comprises a golf putting apparatus including a mat comprising a proximal end, a distal end, a top side and a bottom side; a plurality of distinct resting areas on the top side and near the distal end; a raised ridge on the top side between each of the distinct resting areas; and at least one origin spot on the top side and near the proximal end for placing a ball, such as a golf ball. In one embodiment, a method of improving a user's technique comprises striking a ball from one of the at least one origin spots towards a distinct resting area, such as a preselected resting area.

### PRIORITY CLAIM

This application claims priority to U.S. Provisional Patent Application Ser. No. 62/555,585, filed Sep. 7, 2017, the entire contents of which is incorporated herein by reference and relied upon.

### BACKGROUND

Known practice putting greens used indoors generally suffer from several major shortcomings. For example, most practice putting greens include just one or two cups at which a golfer takes aim. Over time, the golfer's putting stroke becomes specific to the unique characteristics of that specific practice putting green, such as the speed (Stimp), grain direction, contour, etc. Once the golfer tunes his/her putting stroke to that practice putting green, the training benefits of that practice putting green diminish greatly.

Card games, including the genus of games referred to collectively as “poker,” have remained consistently popular forms of entertainment for both gamblers and non-gamblers alike. However, these card games require players to keep at least a portion of their dealt cards secret from other players, and thus spectators also, or to collect dealt cards one at a time. Accordingly, card games played at public events, such as parties, fundraisers, tournaments, charity events, celebrity appearances, and the like often require complicated audio/visual equipment to keep spectators informed of current game play without disclosing each player's dealt cards to his or her competitors.

In addition, traditional card game tournaments may take several hours, or even multiple days, to complete. In certain settings of short durations, such as fundraiser events or charity events, sufficient time to complete a traditional card game tournament may not exist.

A need therefore exists for improved practice putting greens, and for providing new card game devices and methods for playing card games of familiar rules without requiring several hours or complicated audio/visual equipment to operate. The present disclosure provides practice putting greens and game devices and methods that meet that need.

### SUMMARY

The present disclosure provides game devices for playing a card game using a projectile, such as a ball, dart or puck, and methods of playing a card game, like poker, hearts or euchre, using same.

In some embodiments, the present disclosure provides a golf apparatus comprising a mat comprising a proximal end, a distal end, a top side and a bottom side; a plurality of distinct resting areas near the distal end; and at least one origin spot near the proximal end for placing (e.g., delivering, launching, casting, etc.) a projectile, such as a golf ball or puck.

In other embodiments, the present disclosure provides a device for playing a card game, the device comprising a mat comprising a top surface including a proximal zone and a distal zone; a plurality of scoring zones within the distal zone; and at least one player action area within the proximal zone, wherein each of the scoring zones corresponds to a combination of one playing card suit and one playing card rank.

In still other embodiments, the present disclosure provides a device for playing a game on a vertical surface, the device comprising a target board subdivided into a plurality of target zones; and a first hook-and-loop fastener layer on a front-facing surface of the target board for adhering to a ball including a second hook-and-loop fastener that is complimentary to the first hook-and-loop fastener.

In some other embodiments, the present disclosure provides a method of playing a card game, the method comprising causing a first golf ball to come to rest in a first resting area of a scoring zone of a game apparatus, wherein the first resting area corresponds to a first combination of a playing card suit and a playing card rank; causing a second golf ball to come to rest in a second resting area of a scoring zone of the game apparatus, wherein the second resting area corresponds to a second combination of a playing card suit and a playing card rank; causing a third golf ball to come to rest in a third resting area of a scoring zone of the game apparatus, wherein the third resting area corresponds to a third combination of a playing card suit and a playing card rank; causing a fourth golf ball to come to rest in a fourth resting area of a scoring zone of the game apparatus, wherein the fourth resting area corresponds to a fourth combination of a playing card suit and a playing card rank; and causing a fifth golf ball to come to rest in a fifth resting area of a scoring zone of the game apparatus, wherein the fifth resting area corresponds to a fifth combination of a playing card suit and a playing card rank. In some such embodiments, any one or more of the first resting area, the second resting area, the third resting area, the fourth resting area, and/or fifth resting area corresponds to a wild card or a null card.

In still other embodiments, the present disclosure provides a method of playing poker, the method comprising a) enabling a first player to cause a first ball to come to rest in a first scoring zone of a poker game apparatus, the first scoring zone representing a first combination of a playing card suit and a playing card rank; b) enabling a second player to cause a second ball to come to rest in a second scoring zone of the poker game apparatus, the second scoring zone representing a second combination of a playing card suit and a playing card rank; c) enabling the first player to cause a third ball to come to rest in a third scoring zone of the poker game apparatus, the third scoring zone representing a third combination of a playing card suit and a playing card rank; d) enabling the second player to cause a fourth ball to come to rest in a fourth scoring zone of the poker game apparatus, the fourth scoring zone representing a fourth combination of a playing card suit and a playing card rank; e) enabling the first player to cause a fifth ball to come to rest in a fifth scoring zone of the poker game apparatus, the fifth scoring zone representing a fifth combination of a playing card suit and a playing card rank; f) enabling the second player to cause a sixth ball to come to rest in a sixth scoring zone of the poker game apparatus, the sixth scoring zone representing a sixth combination of a playing card suit and a playing card rank; g) enabling the first player to cause a seventh ball to come to rest in a seventh scoring zone of the poker game apparatus, the seventh scoring zone representing a seventh combination of a playing card suit and a playing card rank; h) enabling the second player to cause an eighth ball to come to rest in an eighth scoring zone of the poker game apparatus, the eighth scoring zone representing an eighth combination of a playing card suit and a playing card rank; i) enabling the first player to cause a ninth ball to come to rest in a ninth scoring zone of the poker game apparatus, the ninth scoring zone representing a ninth combination of a playing card suit and a playing card rank; and k) enabling the second player to cause a tenth ball to come to rest in a tenth scoring zone of the poker game apparatus, the tenth scoring zone representing a tenth combination of a playing card suit and a playing card rank.

Almost any poker-style card game may be played using the devices and/or methods disclosed herein. In some embodiments, a device and/or method disclosed herein is used to play black jack (also referred to as “21”). In some embodiments, a device and/or method disclosed herein is used to play Texas Hold 'Em poker. In some embodiments, a device and/or method disclosed herein is used to play Omaha Hold 'Em poker. In some embodiments, a device and/or method disclosed herein is used to play 7-card stud poker. In some embodiments, a device and/or method disclosed herein is used to play 5-card stud poker. In some embodiments, a device and/or method disclosed herein is used to play 7-card draw poker. In some embodiments, a device and/or method disclosed herein is used to play 5-card draw poker.

These and other embodiments are described herein below, with some embodiments particularly described with respect to the Figures appended hereto.

### BRIEF DESCRIPTION OF THE FIGURES

FIG. 1A is a perspective view of a golf training apparatus according to one embodiment of the present disclosure.

FIG. 1B is a perspective view of a golf training apparatus according to another embodiment of the present disclosure.

FIG. 1C is a perspective view of a portion of a golf training apparatus including a plurality of raised ridge segments between and around distinct resting areas according to one embodiment of the present disclosure.

FIG. 2 is a perspective cut-away view of a golf training apparatus according to one embodiment of the present disclosure.

FIG. 3 is a perspective cut-away view of a golf training apparatus according to one embodiment of the present disclosure.

FIG. 4 is a perspective cut-away view of a golf training apparatus according to one embodiment of the present disclosure.

FIG. 5 is a perspective view of a golf training apparatus according to one embodiment of the present disclosure.

FIG. 6 is a perspective view of a sports training device according to one embodiment of the present disclosure.

FIG. 7A is a perspective view of a portion of a sports training device using a ball according to one embodiment of the present disclosure.

FIG. 7B is a perspective view of a portion of a golf training apparatus including a plurality of raised ridge segments between and around scoring zones according to one embodiment of the present disclosure

FIG. 8 is a plan view of a sports training device including a vertical target surface according to one embodiment of the present disclosure, optionally further including a rug or mat from which a projectile is launched toward the device.

FIG. 9 is a perspective view of a sports training device including a vertical target surface, such as a ball, and further including a rug or mat from which a projectile is launched toward the device, according to one embodiment of the present disclosure.

FIG. 10A shows a design for a distinct resting area according to one embodiment of the present disclosure.

FIG. 10B shows a design for a distinct resting area according to another embodiment of the present disclosure.

FIG. 10C shows a design for a distinct resting area according to another embodiment of the present disclosure.

FIG. 10D shows a design for a distinct resting area according to another embodiment of the present disclosure.

FIG. 10E shows a design for a distinct resting area according to another embodiment of the present disclosure.

FIG. 11A shows a design for a distinct resting area representing a wild card according to one embodiment of the present disclosure.

FIG. 11B shows a design for a distinct resting area representing a wild card according to another embodiment of the present disclosure.

FIG. 12A shows a design for a distinct resting area representing a wild card according to another embodiment of the present disclosure.

FIG. 12B shows a design for a distinct resting area representing a wild card according to another embodiment of the present disclosure.

FIG. 13 shows a design for a distinct resting area representing a wild card according to another embodiment of the present disclosure.

FIG. 14 shows a design for a distinct resting area representing a wild card according to another embodiment of the present disclosure.

FIG. 15 shows a design for a distinct resting area representing a wild card according to another embodiment of the present disclosure.

FIG. 16A shows a design for a distinct resting area representing a wild card according to another embodiment of the present disclosure.

FIG. 16B shows a design for a distinct resting area representing a stymie action instruction according to another embodiment of the present disclosure.

FIG. 17A shows an arrangement of distinct resting areas enabling one or more players to lodge projectiles towards the same distinct resting areas from any angle and/or enabling play on natural turf while minimizing repetitive use damage from a small number of origin spots, according to one embodiment of the present disclosure.

FIG. 17B shows an alternative arrangement of distinct resting areas enabling one or more players to lodge projectiles towards the same distinct resting areas from any angle and/or enabling play on natural turf while minimizing repetitive use damage from a small number of origin spots, according to another embodiment of the present disclosure

FIG. 18A shows a stencil design including distinct resting areas according to one embodiment of the present disclosure.

FIGS. 18B and 18C show the stencil design of FIG. 18A divided into (1) red playing cards and wild card resting areas (FIG. 18B), and (2) black playing card resting areas (FIG. 18C).

FIG. 18D shows the stencil design of FIG. 18A divided into distinct rows of distinct resting areas, which in turn are each divided into (1) red playing cards and wild card resting areas, and (2) black playing card resting areas.

FIG. 19 shows an exemplary score card for keeping score of game play associated with use of a game device as disclosed herein.

FIG. 20 representatively shows an electronic game machine according to one embodiment of the present disclosure.

FIG. 21A shows one embodiment of a stymie device for use with a game apparatus disclosed herein.

FIG. 21B shows one embodiment of a stymie device for use with a game apparatus disclosed herein.

FIG. 21C shows one embodiment of a stymie device for use with a game apparatus disclosed herein.

FIG. 22 shows a stymie device placed on the surface of a game apparatus according to one embodiment as disclosed herein.

FIGS. 23A-23C collectively show a method for electronically playing a card game using an electronically rendered golf course according to one embodiment of the present disclosure.

FIG. 24 shows one embodiment of a golf training apparatus according to one embodiment of the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

The present disclosure provides game devices for playing a game, such as a card game, using a projectile (e.g., a ball such as a golf ball, a puck, a chip, a dart, or a hook-and-loop covered article), methods of making game devices disclosed herein, and methods of playing a game, such as a card game like poker, using same.

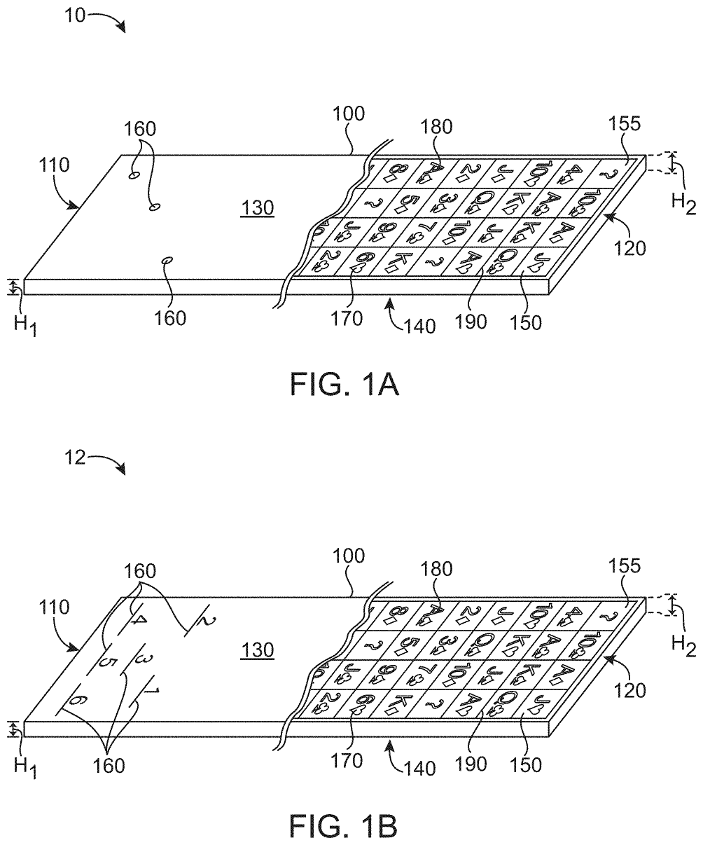

Referring generally to FIGS. 1A-24, the game systems of the present disclosure provide means for playing a game, such as a card game, using an unconventional method. For example, the game systems of the present disclosure may, in some embodiments, allow players to complete at a card game such as poker without the use of a single playing card. In other embodiments, the game systems of the present disclosure enable players to compete at a card game (e.g., poker) in conjunction with a deck of playing cards (or a portion thereof), introducing a new skill-based element to typical card game.

The present game systems and methods of using same offer significant advantages over conventional means of playing a card game. For example and without limitation, the presently disclosed game systems enable spectators to follow game play without requiring expensive and complicated audio visual equipment, as is commonly used in card game tournaments. In addition, the game systems disclosed herein enable players having widely different card game skills to compete much more equivalently in a card game.

Game systems consistent with the present disclosure can also enable faster game play for certain games compared to conventional rules. For example, poker tournaments played using conventional playing cards can last hours or even days. In contrast, a poker tournament using a game system consistent with the present disclosure can shorten game play significantly because at least a portion of each outcome is based at least in part on the result of a physical action (e.g., putting a golf ball) and a player's motor skills, rather than exclusively on the player's mental strategy and the order of the playing cards in the card deck.

In view of these clear advantages, and other advantages that will be apparent to one of ordinary skill in the art based on the accompanying description and figures, the game systems and methods of use thereof disclosed herein enable card games to be played in new situations typically unsuitable for traditional card game tournaments. For example and without limitation, the game systems and methods of use thereof described herein are suitable for use at fundraisers, charity events, block parties, family gatherings (e.g., reunions), tailgate parties, corporate events, team-building events, and the like. In addition, the game systems and methods of use thereof disclosed herein enable card game play indoors and/or in weather conditions unsuitable for traditional card tournaments, such as during rain showers, in high winds, etc.

In certain embodiments disclosed herein, a game system consistent with the present disclosure enables a single player to compete (1) against himself/herself, (2) against one or more remote opponents, and/or (3) against a computerized virtual opponent. Such flexibility enables game play in locations where space is limited, such as a bedroom, a living room, a corporate office, or a small restaurant or bar, and at any time of day or night without requiring all game players to be in the same physical location.

Furthermore, game systems and methods of using same disclosed herein offer a unique incentive for golfers to practice putting accuracy, which typically accounts for 30-50% of a golfer's stroke count per 18 holes. Poor putting has long been recognized as a predominant and persistent problem affecting golfers of all skill levels. Thus, use of the game systems disclosed herein may in some embodiments improve a golfer's putting skills which may be reflected in, for example, an improved golf handicap.

### Devices for Improving Player Skills

Referring now specifically to FIG. 1A, a game system 10 according to one embodiment of the present disclosure comprises a mat 100. The mat 100 comprises at least a proximal end 110, a distal end 120, a top surface 130 and a bottom surface 140.

The proximal end 110 generally refers to an area of the mat 100 where a player performs a task, such as striking a golf ball or projecting a game play piece, towards the distal end 120. The distal end 120 is generally located opposite the proximal end 110. Although the mat 100 is shown in FIG. 1A to be generally rectangular, the mat 100 may be any suitable shape such as a circle, an oval, regular polygon, irregular polygon, rounded polygon, triangle, a right triangle, an equilateral triangle, a quadrilateral, a parallelogram, a rectangle, a square, a trapezoid, a kite, a regular pentagon, an irregular pentagon, a regular hexagon, an irregular hexagon, a truncated circle, or a squircle.

One or more origin spots 160 are located near the proximal end 110. In some embodiments, the origin spot(s) 160 may be a graphic element, such as a differently colored spot. In other embodiments, the origin spot(s) 160 comprise an indentation in the surface 130 of the mat 100 to stabilize a ball that has been placed into a origin spot 160. In some embodiments, the origin spot(s) 160 comprise a combination of an indentation and a differently colored graphic.

In embodiments wherein more than one origin spot 160 is present, each origin spot 160 may be located at a different distance and/or at a different angle from the distal end 120, and may optionally each include a unique colored graphic. During game play, which is described in greater detail below, a die may be used to determine which origin spot 160 (e.g., tee box) should be used by the player for each shot. Alternatively, players with relatively greater golf skill may use a origin spot 160 that is farther from the distal end 120 than an opponent with relatively less golf skill to improve competition between the players using a single game system 10.

At least one distinct resting area 150 is located near the distal end 120. The distinct resting area(s) 150 each represent specific playing cards in some embodiments. In some embodiments, the game system 10 includes at least 10 distinct resting areas 150, for example at least 10 distinct resting areas 150, at least 11 distinct resting areas 150, at least 12 distinct resting areas 150, at least 13 distinct resting areas 150, at least 14 distinct resting areas 150, at least 15 distinct resting areas 150, at least 16 distinct resting areas 150, at least 17 distinct resting areas 150, at least 18 distinct resting areas 150, at least 19 distinct resting areas 150, at least 20 distinct resting areas 150, at least 21 distinct resting areas 150, at least 22 distinct resting areas 150, at least 23 distinct resting areas 150, at least 24 distinct resting areas 150, at least 25 distinct resting areas 150, at least 26 distinct resting areas 150, at least 27 distinct resting areas 150, at least 28 distinct resting areas 150, at least 29 distinct resting areas 150, at least 30 distinct resting areas 150, at least 31 distinct resting areas 150, at least 32 distinct resting areas 150, at least 33 distinct resting areas 150, at least 34 distinct resting areas 150, at least 35 distinct resting areas 150, at least 36 distinct resting areas 150, at least 37 distinct resting areas 150, at least 38 distinct resting areas 150, at least 39 distinct resting areas 150, at least 40 distinct resting areas 150, at least 41 distinct resting areas 150, at least 42 distinct resting areas 150, at least 43 distinct resting areas 150, at least 44 distinct resting areas 150, at least 45 distinct resting areas 150, at least 46 distinct resting areas 150, at least 47 distinct resting areas 150, at least 48 distinct resting areas 150, at least 49 distinct resting areas 150, at least 50 distinct resting areas 150, at least 51 distinct resting areas 150, at least 52 distinct resting areas 150, or more than 52 distinct resting areas 150.

Accordingly, in some such embodiments, each distinct resting area 150 comprises a playing card suit indicator 170 and/or a playing card rank indicator 180. In some embodiments, each combination of a specific playing card suit indicator 170 and a specific playing card rank indicator 180 is represented by no more than one distinct resting area 150. In some embodiments, certain combinations of specific playing card suit indicators 170 and specific playing card rank indicators 180 are not represented by any distinct resting areas 150. In other embodiments, each of the 52 unique combinations of a playing card suit indicator 170 and a playing card rank indicator 180 are represented by one or more distinct resting areas 150. Thus, millions of unique arrangements of the distinct resting areas 150 are possible, providing essentially limitless variety for users of the disclosed devices.

In some embodiments, one or more distinct resting area 150 represents a wild card 155. In such embodiments, the resting area 150 representing a wild card 155 does not include at least one of a playing card suit indicator 170 or a playing card rank indicator 180. In some embodiments, at least one resting area 150 representing a wild card includes a playing card suit indicator 170 but no playing card rank indicator 180. In some embodiments, at least one resting area 150 representing a wild card 155 includes a playing card rank indicator 180 but no playing card suit indicator 170. More than one distinct resting area 150 representing a wild card 155 may be present.

In some embodiments, the mat 100 includes one or more ridges 190 protruding upwards from the top side 130 of the mat 100. The one or more ridges 190 may in some embodiments separate adjacent distinct resting areas 150. The one or more ridges 190 in some embodiments protrude upwards from the top side 130 of the mat 100 a sufficient distance to prevent a projected object, such as a golf ball, from coming to rest between two adjacent distinct resting areas 150, without preventing the projected object (e.g., a golf ball) from rolling from one distinct resting area 150 to an adjacent distinct resting area 150. For example, in some embodiments, the one or more ridges 190 may protrude upwards from the top surface 130 of the mat 100 by about 0.1 mm, about 0.15 mm about 0.2 mm, about 0.25 mm, about 0.3 mm, about 0.35 mm, about 0.4 mm, about 0.45 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 10 mm, or more than about 10 mm. In some embodiments, the one or more ridges 190 protrude upwards from the top surface 130 of the mat 100 by at least about 0.15 mm and by not more than about 0.6 mm, for example at least about 0.15 mm and not more than about 0.6 mm, at least about 0.2 mm and not more than about 0.4 mm, or not more than about 0.5 mm. In some embodiments, the one or more ridges 190 protrude upwards from the top surface 130 of the mat 100 by at least about 0.2 mm and not more than about 0.4 mm. In some embodiments, one or more ridges 190 surrounding a resting area 150 representing a highly desirable playing card (e.g., a distinct resting area 150 having a playing card rank indicator 180 of jack, queen, king or ace) protrudes upwards from the surface 130 of the mat 100 a greater distance than one or more ridges 190 surrounding a resting area 150 representing a less desirable playing card (e.g., a resting area 150 having a playing card rank indicator 180 comprising the number 2, 3, 4, 5, 6, 7, 8, 9, or 10).

In some embodiments, the raised ridge 190 comprises a continuous ridge extending substantially the entire perimeter around each resting area 150.

In other embodiments, such as shown in FIG. 1C, the raised ridge 190 comprises a plurality of raised ridge segments 190a that in combination surround each resting area 150. In such embodiments, each raised ridge segment 190a may have any suitable topographical shape, such as a circular topographical shape, a rectangular topographical shape, a square topographical shape, or an oblong topographical shape. In embodiments wherein the raised ridge segments 190a have a circular topographical shape, each circular raised ridge segment 190a may protrude from the top surface 130 of the mat 100 by at least about 0.15 mm and by not more than about 0.6 mm, and may have a diameter of at least about 0.15 mm and not more than about 4 mm, for example at least about 1 mm and not more than about 4 mm. In embodiments wherein the raised ridge segments 190a have a topographical shape other than a circular topographical shape, each raised ridge segment 190a may have a length of about 0.15 mm to about 30 mm, and a width of about 0.15 mm to about 4 mm.

In some embodiments, such as shown in FIG. 1C, a space 190b separates two adjacent raised ridge segments 190a. In some embodiments, the space 190b between two adjacent raised ridge segments is no more than about 10 mm. In some embodiments, the space 190b between two adjacent raised ridge segments is no more than about 9 mm. In some embodiments, the space 190b between two adjacent raised ridge segments is no more than about 8 mm. In some embodiments, the space 190b between two adjacent raised ridge segments is no more than about 7 mm. In some embodiments, the space 190b between two adjacent raised ridge segments is no more than about 6 mm.

In some embodiments, the space 190b between two adjacent raised ridge segments is no more than about 5 mm. In some embodiments, the space 190b between two adjacent raised ridge segments is no more than about 4 mm. In some embodiments, the space 190b between two adjacent raised ridge segments is no more than about 3 mm. In some embodiments, the space 190b between two adjacent raised ridge segments is no more than about 2 mm. In some embodiments, the space 190b between two adjacent raised ridge segments is no more than about 1 mm.

Embodiments wherein the raised ridges 190 comprise a plurality of raised ridge segments 190a have been found to be significantly more durable when subjected to repeated cycles of (a) rolling the mat 100 into a cylindrical shape and (b) unrolling the mat 100 to form a flattened playing surface compared to raised ridges 190 formed of continuous lengths of ridge material. In some embodiments, less than about 1% of the raised ridge segments 190a dissociate from the top surface 130 when the mat 100 is rolled into a cylindrical shape and subsequently unrolled to form a flat playing surface. In some embodiments, less than about 0.5% of the raised ridge segments 190a dissociate from the top surface 130 when the mat 100 is rolled into a cylindrical shape and subsequently unrolled to form a flattened playing surface. In some embodiments, less than about 0.1% of the raised ridge segments 190a dissociate from the top surface 130 when the mat 100 is rolled into a cylindrical shape and subsequently unrolled to form a flattened playing surface. In some embodiments, less than about 0.05% of the raised ridge segments 190a dissociate from the top surface 130 when the mat 100 is rolled into a cylindrical shape and subsequently unrolled to form a flattened playing surface. In some embodiments, less than about 0.01% of the raised ridge segments 190a dissociate from the top surface 130 when the mat 100 is rolled into a cylindrical shape and subsequently unrolled to form a flattened playing surface. In some embodiments, less than about 0.005% of the raised ridge segments 190a dissociate from the top surface 130 when the mat 100 is rolled into a cylindrical shape and subsequently unrolled to form a flattened playing surface. In some embodiments, less than about 0.001% of the raised ridge segments 190a dissociate from the top surface 130 when the mat 100 is rolled into a cylindrical shape and subsequently unrolled to form a flattened playing surface.

In embodiments wherein the raised ridges 190 comprise a plurality of raised ridge segments 190a, each raised ridge segment 190a may be formed of a more rigid material than elastomeric material suitable for forming continuous raised ridges. For example and without limitation, each raised ridge segment 190a that, when combined, form a raised ridge 190, in some embodiments, may be formed of an epoxy, a rigid plastic (e.g., polyethylene, polycarbonate, polyethylene terephthalate, polyvinyl chloride, polypropylene, acrylic, acetal, or ABS plastic). Spaces separating each raised ridge segment 190a impart a pseudo-flexibility to the raised ridges 190 in such embodiments, imparting excellent durability properties to the raised ridges 190 while the mat 100 retains convenient transport and storage properties offered by embodiments including a continuous raised ridge 190 formed of a more flexible (e.g., elastomeric) material.

In some embodiments, the one or more ridges 190 comprise a polymeric material, such as rubber, polyethylene, polypropylene, or polycarbonate. In other embodiments, the one or more ridges 190 are formed of paint. In other embodiments, the one or more ridges 190 comprise carpet of a higher pile than surrounding areas. In other embodiments, the one or more ridges 190 comprise a metallic material, such as brass, steel, iron, or aluminum.

In some embodiments, the mat 100 features a relatively uniform thickness, such that H₁ is about the same as H₂. In other embodiments, the mat 100 features a greater thickness at or near the distal end 120 than the thickness at or near the proximal end 110, such that H₂ is greater than H₁. In other embodiments, the mat 100 features a greater thickness at or near the proximal end 110 than the thickness at or near the distal end 120, such that H₁ is greater than H₂.

In some embodiments, the mat 100 is flexible, for example so that the game system 10 can be rolled up for transport or storage. Flexibility in the mat 100 also enables the user to insert objects under the mat 100 to, for example, level the game system 10 when placed on an uneven surface, or to incorporate localized areas of slope to simulate natural golf course “breaks” incorporated into putting greens. In some embodiments, a segment of rope or a piece of foam may be placed under a flexible mat 100 in order to increase or decrease a localized area of slope at the top surface 130 of the mat 100.

In some embodiments, the mat 100 comprises a plastic sheet on which the distinct resting areas 150, wild card areas 155, and ridges 190 (e.g., borders) are printed.

In some embodiments, the top surface 130 of the mat 100 includes a texture, such as a grass-like texture. In some embodiments, the texture of the top surface 130 simulates the texture of live bent grass. In some embodiments, the texture of the top surface 130 simulates the texture and grain of Bermuda grass. In some embodiments, the top surface 130 of the mat 100 comprises an artificial turf material, such as a GB-006 nylon putting turf (Southwest Greens, Dalton Ga.) or a polyurethane artificial turf carpet (e.g., Putt Putt Pro putting green turf, Georgia Carpet Industries, Dalton Ga.). In other embodiments, the top surface 130 of the mat 100 comprises a woven fiber (e.g., wool, nylon, viscose, polyurethane, jute, viscose, coir, mountain grass, seagrass, sisal, or tencel) carpet.

In some embodiments, the top surface 130 has a stimp rating of about 7 to about 14, such as about 7, about 8, about 9, about 10, about 11, about 12, about 13, or about 14. In some embodiments, the top surface 130 has a stimp rating of about 11.

In some embodiments, the top surface 130 further includes a graphic element 135. In some embodiments, the graphic element 135 comprises a word, a phrase, a pictorial design, a corporate logo, an advertisement, or a combination of any two or more of the foregoing.

In some embodiments, the game system 10 further includes edging (not shown) surrounding the perimeter of the mat 100. In some embodiments, the edging extends from the top surface 130 of the mat 100 down toward the floor, for example to reduce the risk that a user trips on the edge of the mat 100. In other embodiments, at least a portion of the edging extends higher than the top surface 130 to prevent a ball from rolling off the mat 100. For example, in some embodiments, a portion of the edging associated with the distal end 120 may extend at least about 0.5 inches, such as about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, or more than about 2 inches above the top surface 130 of the mat 100. In some embodiments, the edging comprises, consists essentially of, or consists of rubber. In some embodiments, the edging comprises, consists essentially of, or consists of fabric. In some embodiments, the game system 10 does not include edging surrounding the perimeter of the mat 100.

In some embodiments, the distinct resting areas 150 can be rearranged with respect to each other on the top surface 130 of the mat 100. In such embodiments, each distinct resting area 150 may be a separate piece which may be placed on the mat 100 at any desired location. In such embodiments, each distinct resting area 150 may have a regular shape, such as a square, a rectangle, a regular pentagon, a regular hexagon, a regular octagon, or the like. In other embodiments, the distinct resting areas 150 remain in fixed locations on the mat 100, while each playing card suit indicator 170 and/or each playing card rank indicator 180 and/or each wild card indicator 155 may be separately placed within any desired distinct resting area 150. In any such embodiment, the rearrangeable distinct resting areas 150, rearrangeable playing card rank indicators 170, and/or rearrangeable playing card rank indicators 180 may be attached to the mat 100 by any suitable means including, for example, by double-sided tape (e.g., VELCRO), complementary magnets, static charge, gravity, carpet tape, or removeable adhesive. In other embodiments, the distinct resting areas 150 do not include playing card suit indicators 170 or playing card rank indicators 180, but instead are sized sufficiently to allow one or more playing cards to be placed inside each distinct resting area 150.

As shown in FIG. 1B, a game system 12 according to one embodiment of the present disclosure comprises a mat 100. The mat 100 comprises at least a proximal end 110, a distal end 120, a top surface 130 and a bottom surface 140. The proximal end 110 generally refers to an area of the mat 100 where a player performs a task, such as striking a golf ball or projecting a game play piece, towards the distal end 120. The distal end 120 is generally located opposite the proximal end 110. Although the mat 100 is shown in FIG. 1B to be generally rectangular, the mat 100 may be any suitable shape such as a circle, an oval, regular polygon, irregular polygon, rounded polygon, triangle, a right triangle, an equilateral triangle, a quadrilateral, a parallelogram, a rectangle, a square, a trapezoid, a kite, a regular pentagon, an irregular pentagon, a regular hexagon, an irregular hexagon, a truncated circle, or a squircle.

Six origin spots 160 are located near the proximal end 110, and are shown as distinct lines numbered 1-6. During game play, which is described in greater detail below, a die may be used to determine which origin spot 160 should be used by the player. Alternatively, players with relatively greater golf skill may use a origin spot 160 that is farther from the distal end 120 than an opponent with relatively less golf skill to improve competition between the players using a single game system 12.

At least one distinct resting area 150 is located near the distal end 120. The distinct resting area(s) 150 each represent specific playing cards in some embodiments. In some embodiments, the game system 12 includes at least 10 distinct resting areas 150, for example at least 10 distinct resting areas 150, at least 11 distinct resting areas 150, at least 12 distinct resting areas 150, at least 13 distinct resting areas 150, at least 14 distinct resting areas 150, at least 15 distinct resting areas 150, at least 16 distinct resting areas 150, at least 17 distinct resting areas 150, at least 18 distinct resting areas 150, at least 19 distinct resting areas 150, at least 20 distinct resting areas 150, at least 21 distinct resting areas 150, at least 22 distinct resting areas 150, at least 23 distinct resting areas 150, at least 24 distinct resting areas 150, at least 25 distinct resting areas 150, at least 26 distinct resting areas 150, at least 27 distinct resting areas 150, at least 28 distinct resting areas 150, at least 29 distinct resting areas 150, at least 30 distinct resting areas 150, at least 31 distinct resting areas 150, at least 32 distinct resting areas 150, at least 33 distinct resting areas 150, at least 34 distinct resting areas 150, at least 35 distinct resting areas 150, at least 36 distinct resting areas 150, at least 37 distinct resting areas 150, at least 38 distinct resting areas 150, at least 39 distinct resting areas 150, at least 40 distinct resting areas 150, at least 41 distinct resting areas 150, at least 42 distinct resting areas 150, at least 43 distinct resting areas 150, at least 44 distinct resting areas 150, at least 45 distinct resting areas 150, at least 46 distinct resting areas 150, at least 47 distinct resting areas 150, at least 48 distinct resting areas 150, at least 49 distinct resting areas 150, at least 50 distinct resting areas 150, at least 51 distinct resting areas 150, at least 52 distinct resting areas 150, or more than 52 distinct resting areas 150.

Accordingly, in some such embodiments, each distinct resting area 150 comprises a playing card suit indicator 170 and/or a playing card rank indicator 180. In some embodiments, each combination of a specific playing card suit indicator 170 and a specific playing card rank indicator 180 is represented by no more than one distinct resting area 150. In some embodiments, certain combinations of specific playing card suit indicators 170 and specific playing card rank indicators 180 are not represented by any distinct resting areas 150. In other embodiments, each of the 52 unique combinations of a playing card suit indicator 170 and a playing card rank indicator 180 are represented by one or more distinct resting areas 150. Thus, millions of unique arrangements of the distinct resting areas 150 are possible, providing essentially limitless variety for users of the disclosed devices.

In some embodiments, one or more distinct resting area 150 represents a wild card 155. In such embodiments, the resting area 150 representing a wild card 155 does not include at least one of a playing card suit indicator 170 or a playing card rank indicator 180. In some embodiments, at least one resting area 150 representing a wild card includes a playing card suit indicator 170 but no playing card rank indicator 180. In some embodiments, at least one resting area 150 representing a wild card 155 includes a playing card rank indicator 180 but no playing card suit indicator 170. More than one distinct resting area 150 representing a wild card 155 may be present.

In some embodiments, the mat 100 includes one or more ridges 190 protruding upwards from the top side 130 of the mat 100. The one or more ridges 190 may in some embodiments separate adjacent distinct resting areas 150. The one or more ridges 190 in some embodiments protrude upwards from the top side 130 of the mat 100 a sufficient distance to prevent a projected object, such as a golf ball, from coming to rest between two adjacent distinct resting areas 150, without preventing the projected object (e.g., a golf ball) from rolling from one distinct resting area 150 to an adjacent distinct resting area 150. For example, in some embodiments, the one or more ridges 190 may protrude upwards from the top surface 130 of the mat 100 by about 0.1 mm, about 0.15 mm about 0.2 mm, about 0.25 mm, about 0.3 mm, about 0.35 mm, about 0.4 mm, about 0.45 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 10 mm, or more than about 10 mm. In some embodiments, the one or more ridges 190 protrude upwards from the top surface 130 of the mat 100 by at least about 0.15 mm and by not more than about 0.6 mm, for example at least about 0.15 mm and not more than about 0.6 mm, at least about 0.2 mm and not more than about 0.4 mm, or not more than about 0.5 mm. In some embodiments, the one or more ridges 190 protrude upwards from the top surface 130 of the mat 100 by at least about 0.2 mm and not more than about 0.4 mm. In some embodiments, one or more ridges 190 surrounding a resting area 150 representing a highly desirable playing card (e.g., a distinct resting area 150 having a playing card rank indicator 180 of jack, queen, king or ace) protrudes upwards from the surface 130 of the mat 100 a greater distance than one or more ridges 190 surrounding a resting area 150 representing a less desirable playing card (e.g., a resting area 150 having a playing card rank indicator 180 comprising the number 2, 3, 4, 5, 6, 7, 8, 9, or 10).

In some embodiments, the raised ridge comprises a continuous ridge extending substantially the entire perimeter around each resting area 150.

In other embodiments, the raised ridge comprises a plurality of raised ridge segments that in combination surround each resting area 150. In such embodiments, each raised ridge segment may have any suitable topographical shape, such as a circular topographical shape, a rectangular topographical shape, a square topographical shape, or an oblong topographical shape. In embodiments wherein the raised ridge segments have a circular topographical shape, each circular raised ridge may protrude from the top surface 130 of the mat 100 by at least about 0.15 mm and by not more than about 0.6 mm, and may have a diameter of at least about 0.15 mm and not more than about 4 mm, for example at least about 1 mm and not more than about 4 mm. In embodiments wherein the raised ridge segments have a topographical shape other than a circular topographical shape, each raised ridge segment may have a length of about 0.15 mm to about 30 mm, and a width of about 0.15 mm to about 4 mm.

In some embodiments, a space 190b separates two adjacent raised ridge segments 190a. In some embodiments, the space 190b between two adjacent raised ridge segments is no more than about 10 mm. In some embodiments, the space 190b between two adjacent raised ridge segments is no more than about 9 mm. In some embodiments, the space 190b between two adjacent raised ridge segments is no more than about 8 mm. In some embodiments, the space 190b between two adjacent raised ridge segments is no more than about 7 mm. In some embodiments, the space 190b between two adjacent raised ridge segments is no more than about 6 mm. In some embodiments, the space 190b between two adjacent raised ridge segments is no more than about 5 mm. In some embodiments, the space 190b between two adjacent raised ridge segments is no more than about 4 mm. In some embodiments, the space 190b between two adjacent raised ridge segments is no more than about 3 mm. In some embodiments, the space 190b between two adjacent raised ridge segments is no more than about 2 mm. In some embodiments, the space 190b between two adjacent raised ridge segments is no more than about 1 mm.

Embodiments wherein the raised ridges comprise a plurality of raised ridge segments have been found to be significantly more durable when subjected to repeated cycles of (a) rolling the mat 100 into a cylindrical shape and (b) unrolling the mat 100 to form a flattened playing surface. In some embodiments, less than about 1% of the raised ridge segments 190a dissociate from the top surface 130 when the mat 100 is rolled into a cylindrical shape and subsequently unrolled to form a flat playing surface. In some embodiments, less than about 0.5% of the raised ridge segments 190a dissociate from the top surface 130 when the mat 100 is rolled into a cylindrical shape and subsequently unrolled to form a flattened playing surface. In some embodiments, less than about 0.1% of the raised ridge segments 190a dissociate from the top surface 130 when the mat 100 is rolled into a cylindrical shape and subsequently unrolled to form a flattened playing surface. In some embodiments, less than about 0.05% of the raised ridge segments 190a dissociate from the top surface 130 when the mat 100 is rolled into a cylindrical shape and subsequently unrolled to form a flattened playing surface. In some embodiments, less than about 0.01% of the raised ridge segments 190a dissociate from the top surface 130 when the mat 100 is rolled into a cylindrical shape and subsequently unrolled to form a flattened playing surface. In some embodiments, less than about 0.005% of the raised ridge segments 190a dissociate from the top surface 130 when the mat 100 is rolled into a cylindrical shape and subsequently unrolled to form a flattened playing surface. In some embodiments, less than about 0.001% of the raised ridge segments 190a dissociate from the top surface 130 when the mat 100 is rolled into a cylindrical shape and subsequently unrolled to form a flattened playing surface.

In embodiments wherein the raised ridges 190 comprise a plurality of raised ridge segments 190a, each raised ridge segment 190a may be formed of a more rigid material than elastomeric material suitable for forming continuous raised ridges. For example and without limitation, each raised ridge segment 190a that, when combined, form a raised ridge 190, in some embodiments, may be formed of an epoxy, a rigid plastic (e.g., polyethylene, polycarbonate, polyethylene terephthalate, polyvinyl chloride, polypropylene, acrylic, acetal, or ABS plastic). Spaces separating each raised ridge segment 190a impart a pseudo-flexibility to the raised ridges 190 in such embodiments, imparting excellent durability properties to the raised ridges 190 while the mat 100 retains convenient transport and storage properties offered by embodiments including a continuous raised ridge 190 formed of a more flexible (e.g., elastomeric) material.

In some embodiments, the one or more ridges 190 comprise a polymeric material, such as rubber, polyethylene, polypropylene, or polycarbonate. In other embodiments, the one or more ridges 190 are formed of paint. In other embodiments, the one or more ridges 190 comprise carpet of a higher pile than surrounding areas. In other embodiments, the one or more ridges 190 comprise a metallic material, such as brass, steel, iron, or aluminum.

In some embodiments, the mat 100 features a relatively uniform thickness, such that H₁ is about the same as H₂. In other embodiments, the mat 100 features a greater thickness at or near the distal end 120 than the thickness at or near the proximal end 110, such that H₂ is greater than H₁. In other embodiments, the mat 100 features a greater thickness at or near the proximal end 110 than the thickness at or near the distal end 120, such that H₁ is greater than H₂.

In some embodiments, the mat 100 is flexible, for example so that the game system 12 can be rolled up for transport or storage. Flexibility in the mat 100 also enables the user to insert objects under the mat 100 to, for example, level the game system 10 when placed on an uneven surface, or to incorporate localized areas of slope to simulate natural golf course putting greens. In some embodiments, a segment of rope or a piece of foam may be placed under a flexible mat 100 in order to increase or decrease a localized area of slope at the top surface 130 of the mat 100.

In some embodiments, the top surface 130 of the mat 100 includes a texture, such as a grass-like texture. In some embodiments, the texture of the top surface 130 simulates the texture of live bent grass. In some embodiments, the texture of the top surface 130 simulates the texture and grain of Bermuda grass. In some embodiments, the top surface 130 of the mat 100 comprises an artificial turf material, such as a GB-006 nylon putting turf (Southwest Greens, Dalton Ga.) or a polyurethane artificial turf carpet (e.g., Putt Putt Pro putting green turf, Georgia Carpet Industries, Dalton Ga.).

In other embodiments, the top surface 130 of the mat 100 comprises a woven fiber (e.g., wool, nylon, viscose, polyurethane, jute, viscose, coir, mountain grass, seagrass, sisal, or tencel) carpet.

In some embodiments, the top surface 130 has a stimp rating of about 7 to about 14, such as about 7, about 8, about 9, about 10, about 11, about 12, about 13, or about 14. In some embodiments, the top surface 130 has a stimp rating of about 11.

In some embodiments, the top surface 130 further includes a graphic element 135 (not shown). In some embodiments, the graphic element 135 comprises a word, a phrase, a pictorial design, a corporate logo, an advertisement, or a combination of any two or more of the foregoing.

In some embodiments, the game system 10 further includes edging (not shown) surrounding the perimeter of the mat 100. In some embodiments, the edging extends from the top surface 130 of the mat 100 down toward the floor, for example to reduce the risk that a user trips on the edge of the mat 100. In other embodiments, at least a portion of the edging extends higher than the top surface 130 to prevent a ball from rolling off the mat 100. For example, in some embodiments, a portion of the edging associated with the distal end 120 may extend at least about 0.5 inches, such as about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, or more than about 2 inches above the top surface 130 of the mat 100. In some embodiments, the edging comprises, consists essentially of, or consists of rubber. In some embodiments, the edging comprises, consists essentially of, or consists of fabric. In some embodiments, the game system 10 does not include an edging surrounding the perimeter of the mat 100.

In some embodiments, the distinct resting areas 150 can be rearranged with respect to each other on the top surface 130 of the mat 100. In such embodiments, each distinct resting area 150 may be a separate piece which may be placed on the mat 100 at any desired location. In such embodiments, each distinct resting area 150 may have a regular shape, such as a square, a rectangle, a regular pentagon, a regular hexagon, a regular octagon, or the like. In other embodiments, the distinct resting areas 150 remain in fixed locations on the mat 100, while each playing card suit indicator 170 and/or each playing card rank indicator 180 and/or each wild card indicator 155 may be separately placed within any desired distinct resting area 150. In any such embodiment, the rearrangeable distinct resting areas 150, rearrangeable playing card rank indicators 170, and/or rearrangeable playing card rank indicators 180 may be attached to the mat 100 by any suitable means including, for example, by double-sided tape (e.g., VELCRO), complementary magnets, static charge, gravity, carpet tape, or removeable adhesive.

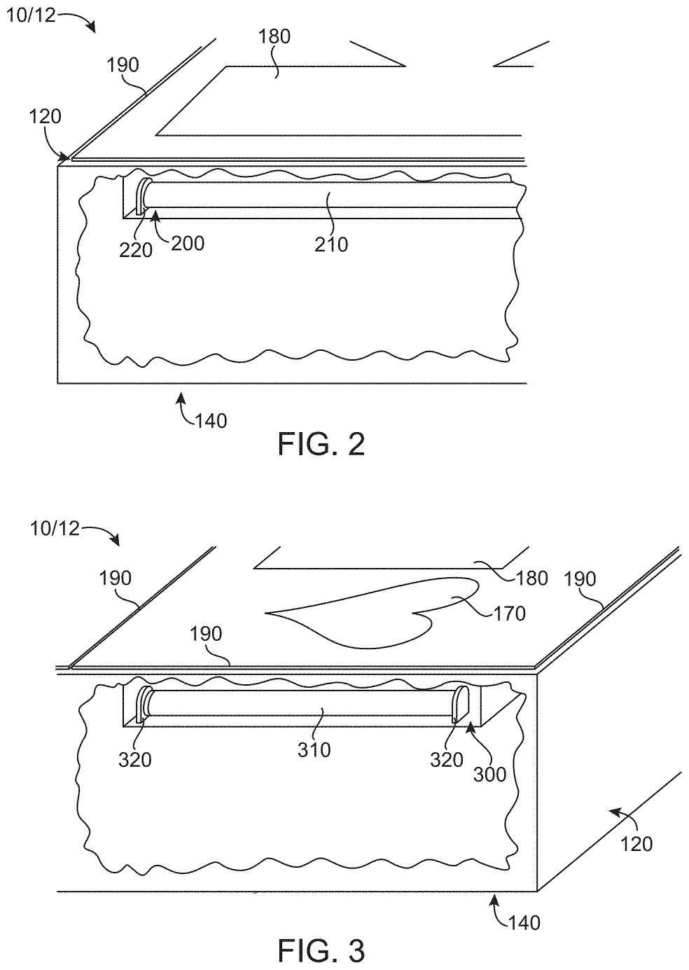

Referring now to FIG. 2, in some embodiments, the game system 10 or game system 12 further includes a playing card rank indicator illumination source 200 for back-lighting the playing card rank indicator 180. The playing card rank illumination source 200 may comprise a light source 210 and an electrical supply 220 for providing electricity to the light source 210. Although the light source 210 is depicted in FIG. 2 to be a fluorescent lamp, any suitable lamp(s) may be used including, for example, halogen lamps, incandescent lamps, or LED lamps.

In such embodiments, the playing card rank indicator 180 may be a void in the distinct resting area 150 such that the light emitted from the playing card rank indicator illumination source 200 shines through the playing card rank indicator 180. In other embodiments, the distinct resting area 150 may allow some or all of the light emitted from the playing card rank indicator illumination source 200 to pass through, while the playing card rank indictor 180 may block all or substantially all of the emitted light. In some embodiments, the game system 10 comprises a combination of playing card rank indicators 180 that allow emitted light to pass through and playing card rank indicators 180 that block all or substantially all of the emitted light from passing through.

Referring now to FIG. 3, in some embodiments, the game system 10 or game system 12 further includes a playing card suit indicator illumination source 300 for back-lighting the playing card suit indicator 170. The playing card suit illumination source 300 may comprise a light source 310 and an electrical supply 320 for providing electricity to the light source 310. Although the light source 310 is depicted in FIG. 3 to be a fluorescent lamp, any suitable lamp(s) may be used including, for example, halogen lamps, incandescent lamps, or LED lamps.

In such embodiments, the playing card suit indicator 170 may be a void in the distinct resting area 150 such that the light emitted from the playing card suit indicator illumination source 300 shines through the playing card suit indicator 170. In other embodiments, the distinct resting area 150 may allow some or all of the light emitted from the playing card suit indicator illumination source 300 to pass through, while the playing card suit indictor 170 may block all or substantially all of the emitted light. In some embodiments, the game system 10 comprises a combination of playing card suit indicators 170 that allow emitted light to pass through and playing card suit indicators 170 that block all or substantially all of the emitted light from passing through.

In some embodiments, the game system 10 includes a single type of illumination source 200/300 that illuminates both the playing card suit indicators 170 and the playing card rank indicators 180.

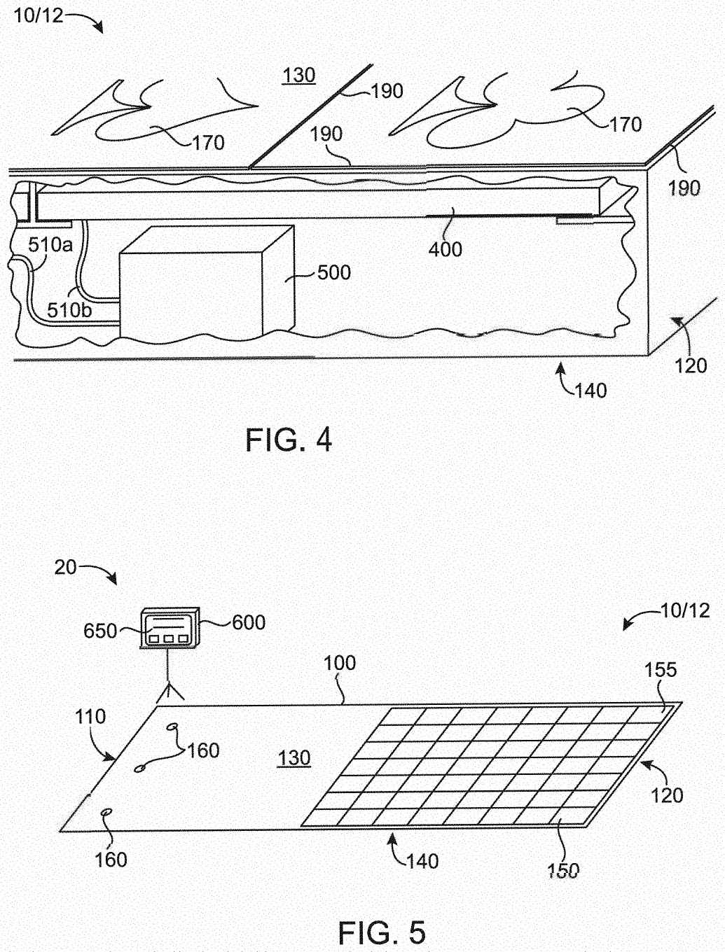

Referring now to FIG. 4, in some embodiments the game system 10 or game system 12 comprises one or more display units 400 for displaying the distinct resting areas 150 on the top surface 130 of the mat 100. Such embodiments may further include one or more processors 500 for controlling the display unit(s) 400. The processor(s) 500 may be in communication with the one or more display units 400 wirelessly (not shown) or through wired connections 510a, 510b, as shown in FIG. 4. Regardless of the type of connectivity, the processor(s) 500 may be housed within the mat 100, as shown in FIG. 4, or as a separate unit from the mat 100 (not shown).

As shown in FIG. 5, a digital game system 20 according to the present disclosure may comprise a game system 10 or game system 12 as described herein and an input device 600. The input device 600, in some embodiments, enables a player to input characteristics such as his or her name, age, e-mail address, and golf handicap. The input device 600 may be in communication with a processor (e.g., the one or more processors 500 of the game system 10 embodiment represented in FIG. 5) that controls game play. For example, in one embodiment, the processor(s) 500 causes the one or more display units 400 to display distinct resting areas 150 in a first pattern representing a relatively more challenging layout for a first player who has input a relatively lower golf handicap into the input device 600, and to display a second pattern representing a relatively less challenging layout for a second player who has input a relatively higher golf handicap into the input device 600.

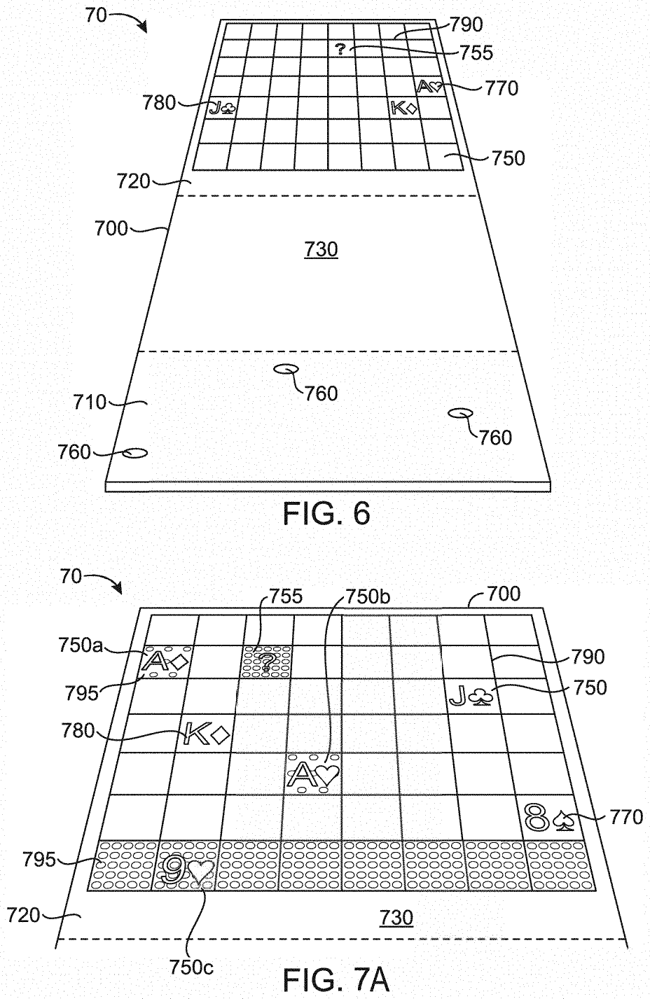

Referring now to FIG. 6, a game system 70 according to the present disclosure comprises a mat 700 that includes a proximal zone 710, a distal zone 720, and a top surface 730. The proximal zone 710 may optionally include one or more player action areas 760, for example where a golf ball may be placed before striking with a golf club. The distal zone 720 includes at least one scoring zone 750. The scoring zone(s) 750 each represent specific playing cards in some embodiments. In some embodiments, the distal zone 720 includes at least 10 scoring zones 750, for example at least 10 scoring zones 750, at least 11 scoring zones 750, at least 12 scoring zones 750, at least 13 scoring zones 750, at least 14 scoring zones 750, at least 15 scoring zones 750, at least 16 scoring zones 750, at least 17 scoring zones 750, at least 18 scoring zones 750, at least 19 scoring zones 750, at least 20 scoring zones 750, at least 21 scoring zones 750, at least 22 scoring zones 750, at least 23 scoring zones 750, at least 24 scoring zones 750, at least 25 scoring zones 750, at least 26 scoring zones 750, at least 27 scoring zones 750, at least 28 scoring zones 750, at least 29 scoring zones 750, at least 30 scoring zones 750, at least 31 scoring zones 750, at least 32 scoring zones 750, at least 33 scoring zones 750, at least 34 scoring zones 750, at least 35 scoring zones 750, at least 36 scoring zones 750, at least 37 scoring zones 750, at least 38 scoring zones 750, at least 39 scoring zones 750, at least 40 scoring zones 750, at least 41 scoring zones 750, at least 42 scoring zones 750, at least 43 scoring zones 750, at least 44 scoring zones 750, at least 45 scoring zones 750, at least 46 scoring zones 750, at least 47 scoring zones 750, at least 48 scoring zones 750, at least 49 scoring zones 750, at least 50 scoring zones 750, at least 51 scoring zones 750, at least 52 scoring zones 750, or more than 52 scoring zones 750.

Each scoring area 750 comprises a playing card suit indicator 770 and/or a playing card rank indicator 780. In some embodiments, each combination of a specific playing card suit indicator 770 and a specific playing card rank indicator 780 is represented by no more than one scoring area 750. In some embodiments, certain combinations of specific playing card suit indicators 770 and specific playing card rank indicators 780 are not represented by any scoring areas 750. In other embodiments, each of the 52 unique combinations of a playing card suit indicator 770 and a playing card rank indicator 780 are represented by one or more scoring zones 750.

In some embodiments, the distal zone 720 further includes one or more wild card zones 755. The one or more wild card zones 755 do not include at least one of a playing card suit indicator 770 or a playing card rank indicator 780. In some embodiments, at least one wild card zone 755 includes a playing card suit indicator 770 but no playing card rank indicator 780. In some embodiments, the wild card zone(s) 755 includes a playing card rank indicator 780 but no playing card suit indicator 770. More than one wild card zone 755 may be present.

In some embodiments, the mat 700 includes one or more ridges 790 protruding upwards from the top side 730 of the mat 700. The one or more ridges 790 may in some embodiments separate adjacent distinct resting areas 750. The one or more ridges 790 in some embodiments protrude upwards from the top side 730 of the mat 700 a sufficient distance to prevent a projected object, such as a golf ball, from coming to rest between two adjacent distinct resting areas 750, without preventing the projected object (e.g., a golf ball) from rolling from one scoring zone 750 or wild card zone 755 to an adjacent scoring zone 750 or wild card zone 755. For example, in some embodiments, the one or more ridges 790 may protrude upwards from the top surface 730 of the mat 700 by about 0.1 mm, about 0.15 mm about 0.2 mm, about 0.25 mm, about 0.3 mm, about 0.35 mm, about 0.4 mm, about 0.45 mm, about 0.5 mm, about 0.6 mm, about 0.7 mm, about 0.8 mm, about 0.9 mm, about 1 mm, about 2 mm, about 3 mm, about 4 mm, about 5 mm, about 6 mm, about 7 mm, about 8 mm, about 9 mm, about 10 mm, or more than about 10 mm. In some embodiments, the one or more ridges 190 protrude upwards from the top surface 130 of the mat 100 by at least about 0.15 mm and by not more than about 0.6 mm, for example at least about 0.15 mm and not more than about 0.6 mm, at least about 0.2 mm and not more than about 0.4 mm, or not more than about 0.5 mm. In some embodiments, one or more ridges 790 surrounding a scoring zone 750 or wild card zone 755 representing a highly desirable playing card (e.g., a scoring zone 750 having a playing card rank indicator 780 of jack, queen, king or ace) protrudes upwards from the surface 730 of the mat 700 a greater distance than one or more ridges 790 surrounding a resting area 750 representing a less desirable playing card (e.g., a scoring zone 750 having a playing card rank indicator 780 comprising the number 2, 3, 4, 5, 6, 7, 8, 9, or 10).

In some embodiments, the raised ridge 790 comprises a continuous ridge extending substantially the entire perimeter around each resting area 750.

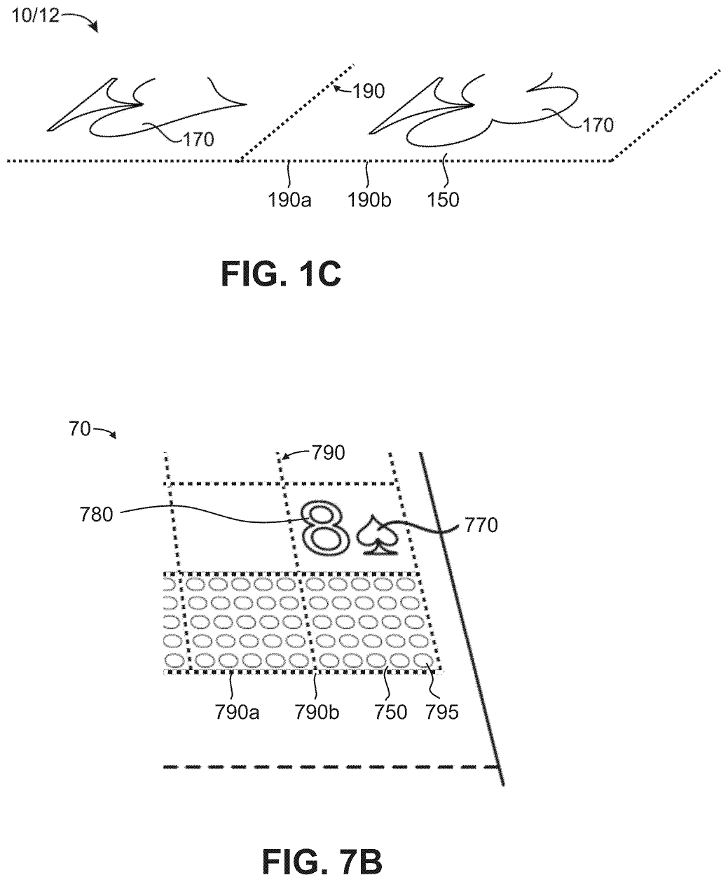

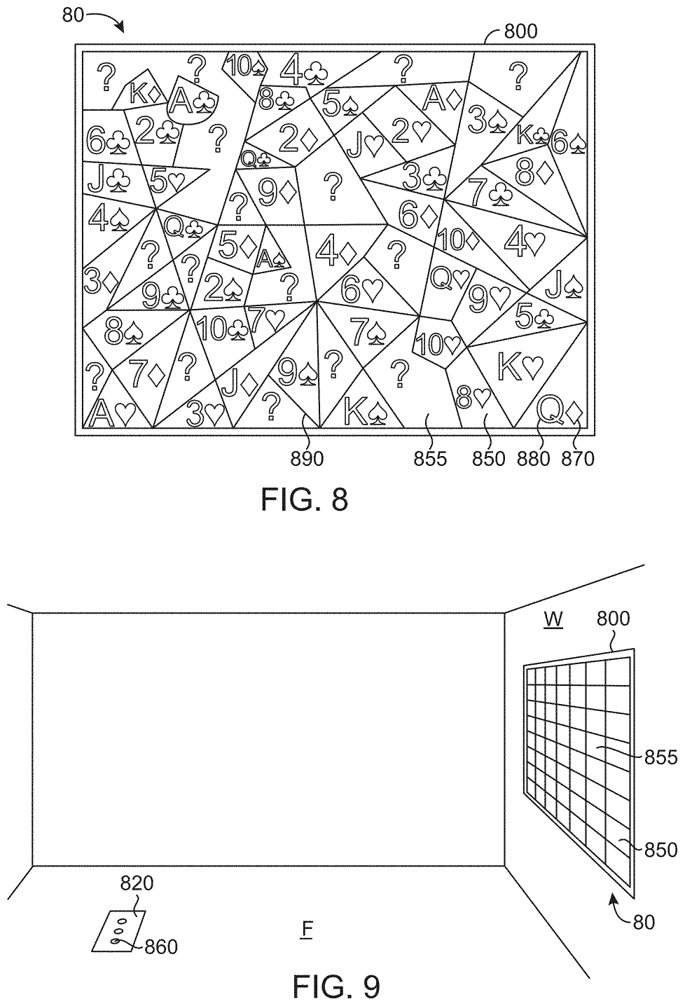

In other embodiments, such as shown in FIG. 7B, the raised ridge 790 comprises a plurality of raised ridge segments 790a that in combination surround each resting area 750. In such embodiments, each raised ridge segment 790a may have any suitable topographical shape, such as a circular topographical shape, a rectangular topographical shape, a square topographical shape, or an oblong topographical shape. In embodiments wherein the raised ridge segments 790a have a circular topographical shape, each circular raised ridge segment 790a may protrude from the top surface 730 of the mat 700 by at least about 0.15 mm and by not more than about 0.6 mm, and may have a diameter of at least about 0.15 mm and not more than about 4 mm, for example at least about 1 mm and not more than about 4 mm. In embodiments wherein the raised ridge segments 790a have a topographical shape other than a circular topographical shape, each raised ridge segment 790a may have a length of about 0.15 mm to about 30 mm, and a width of about 0.15 mm to about 4 mm.

In some embodiments, such as shown in FIG. 7B, a space 790b separates two adjacent raised ridge segments 790a. In some embodiments, the space 790b between two adjacent raised ridge segments is no more than about 10 mm. In some embodiments, the space 790b between two adjacent raised ridge segments is no more than about 9 mm. In some embodiments, the space 790b between two adjacent raised ridge segments is no more than about 8 mm. In some embodiments, the space 790b between two adjacent raised ridge segments is no more than about 7 mm. In some embodiments, the space 790b between two adjacent raised ridge segments is no more than about 6 mm. In some embodiments, the space 790b between two adjacent raised ridge segments is no more than about 5 mm. In some embodiments, the space 790b between two adjacent raised ridge segments is no more than about 4 mm. In some embodiments, the space 790b between two adjacent raised ridge segments is no more than about 3 mm. In some embodiments, the space 790b between two adjacent raised ridge segments is no more than about 2 mm. In some embodiments, the space 790b between two adjacent raised ridge segments is no more than about 1 mm.

Embodiments wherein the raised ridges 790 comprise a plurality of raised ridge segments 790a have been found to be significantly more durable when subjected to repeated cycles of (a) rolling the mat 700 into a cylindrical shape and (b) unrolling the mat 700 to form a flattened playing surface. In some embodiments, less than about 1% of the raised ridge segments dissociate from the top surface 730 when the mat 700 is rolled into a cylindrical shape and subsequently unrolled to form a flat playing surface. In some embodiments, less than about 0.5% of the raised ridge segments dissociate from the top surface 730 when the mat 700 is rolled into a cylindrical shape and subsequently unrolled to form a flattened playing surface. In some embodiments, less than about 0.1% of the raised ridge segments dissociate from the top surface 730 when the mat 700 is rolled into a cylindrical shape and subsequently unrolled to form a flattened playing surface. In some embodiments, less than about 0.05% of the raised ridge segments dissociate from the top surface 730 when the mat 700 is rolled into a cylindrical shape and subsequently unrolled to form a flattened playing surface. In some embodiments, less than about 0.01% of the raised ridge segments dissociate from the top surface 730 when the mat 100 is rolled into a cylindrical shape and subsequently unrolled to form a flattened playing surface. In some embodiments, less than about 0.005% of the raised ridge segments 790a dissociate from the top surface 730 when the mat 700 is rolled into a cylindrical shape and subsequently unrolled to form a flattened playing surface. In some embodiments, less than about 0.001% of the raised ridge segments 790a dissociate from the top surface 730 when the mat 700 is rolled into a cylindrical shape and subsequently unrolled to form a flattened playing surface.

In embodiments wherein the raised ridges 790 comprise a plurality of raised ridge segments 790a, each raised ridge segment 790a may be formed of a more rigid material than elastomeric material suitable for forming continuous raised ridges. For example and without limitation, each raised ridge segment 790a that, when combined, form a raised ridge 790, in some embodiments, may be formed of an epoxy, a rigid plastic (e.g., polyethylene, polycarbonate, polyethylene terephthalate, polyvinyl chloride, polypropylene, acrylic, acetal, or ABS plastic). Spaces separating each raised ridge segment 790a impart a pseudo-flexibility to the raised ridges 790 in such embodiments, imparting excellent durability properties to the raised ridges 790 while the mat 700 retains convenient transport and storage properties offered by embodiments including a continuous raised ridge 790 formed of a more flexible (e.g., elastomeric) material.

In some embodiments, the one or more ridges 790 comprise a polymeric material, such as rubber, polyethylene, polypropylene, or polycarbonate. In other embodiments, the one or more ridges 790 are formed of paint. In other embodiments, the one or more ridges 790 comprise carpet of a higher pile than surrounding areas. In other embodiments, the one or more ridges 790 comprise a metallic material, such as brass, steel, iron, or aluminum.

In some embodiments, the mat 700 is flexible, for example so that the game system 70 can be rolled up for transport or storage. Flexibility in the mat 700 also enables the user to insert objects under the mat 700 to, for example, level the game system 70 when placed on an uneven surface, or to incorporate localized areas of slope to simulate natural golf course putting greens. In some embodiments, a segment of rope or a piece of foam may be placed under a flexible mat 700 in order to increase or decrease a localized area of slope at the top surface 730 of the mat 700.

In some embodiments, the top surface 730 of the mat 700 includes a texture, such as a grass-like texture. In some embodiments, the texture of the top surface 730 simulates the texture of live bent grass. In some embodiments, the texture of the top surface 730 simulates the texture and grain of Bermuda grass. In some embodiments, the top surface 730 of the mat 700 comprises an artificial turf material, such as a GB-006 nylon putting turf (Southwest Greens, Dalton Ga.) or a polyurethane artificial turf carpet (e.g., Putt Putt Pro putting green turf, Georgia Carpet Industries, Dalton Ga.). In other embodiments, the top surface 730 of the mat 700 comprises a woven fiber (e.g., wool, nylon, viscose, polyurethane, jute, viscose, coir, mountain grass, seagrass, sisal, or tencel) carpet.

In some embodiments, the top surface 730 has a stimp rating of about 7 to about 14, such as about 7, about 8, about 9, about 10, about 11, about 12, about 13, or about 14. In some embodiments, the top surface 730 has a stimp rating of about 11.

In some embodiments, the top surface 730 further includes a graphic element 735. In some embodiments, the graphic element 735 comprises a word, a phrase, a pictorial design, a corporate logo, an advertisement, or a combination of any two or more of the foregoing.

In some embodiments, the game system 70 further includes edging (not shown) surrounding the perimeter of the mat 700. In some embodiments, the edging extends from the top surface 730 of the mat 700 down toward the floor, for example to reduce the risk that a user trips on the edge of the mat 700. In other embodiments, at least a portion of the edging extends higher than the top surface 730 to prevent a ball from rolling off the mat 700. For example, in some embodiments, a portion of the edging associated with the distal end 720 may extend at least about 0.5 inches, such as about 0.5 inches, about 0.6 inches, about 0.7 inches, about 0.8 inches, about 0.9 inches, about 1 inches, about 1.1 inches, about 1.2 inches, about 1.3 inches, about 1.4 inches, about 1.5 inches, about 1.6 inches, about 1.7 inches, about 1.8 inches, about 1.9 inches, about 2 inches, or more than about 2 inches above the top surface 730 of the mat 700. In some embodiments, the edging comprises, consists essentially of, or consists of rubber. In some embodiments, the edging comprises, consists essentially of, or consists of fabric.

In some embodiments, the distinct resting areas 750 can be rearranged with respect to each other on the top surface 730 of the mat 700. In such embodiments, each scoring zone 750 and each wild card zone 755 may be a separate piece which may be placed on the mat 700 at any desired location. In such embodiments, each scoring zone 750 may have a regular shape, such as a square, a rectangle, a regular pentagon, a regular hexagon, a regular octagon, or the like. In other embodiments, the scoring zones 750 remain in fixed locations on the mat 700, while each playing card suit indicator 770 and/or each playing card rank indicator 780 and/or each wild card indicator 755 may be separately placed within the distal zone 720. In any such embodiment, the rearrangeable scoring zones 750, the rearrangeable playing card rank indicators 770, the rearrangeable playing card rank indicators 780, and/or the rearrangeable wild card zones 755 may be attached to the mat 700 by any suitable means including, for example, by double-sided tape (e.g., VELCRO), complementary magnets, static charge, carpet tape, or removeable adhesive.

Referring now to FIG. 7, in some embodiments, the scoring zone(s) 750 and the wild card zone(s) 755, if present, comprise one or more indentations 795 for receiving a ball. In some embodiments, each indentation 795 is located entirely within a scoring zone 750 or a wild card zone 755; in such embodiments no individual indentation 795 is located in more than one scoring zone 750, in more than one wild card zone 755, or in both a scoring zone 750 and a wild card zone 755. In such embodiments, a ridge 790 between scoring zones 750 and wild card zones 755 is not necessary, but may be included in some embodiments. In some embodiments, scoring zones 750 having a highly desirable combination of a playing card suit indicator 770 and a playing card rank indicator 780 may include relatively fewer indentations 795 than scoring zones having less desirable combinations of a playing card suit indicator 770 and a playing card rank indicator 780. For example, as shown in FIG. 7, the scoring zones 750a, 750b representing the ace of diamonds and the ace of hearts respectively each have fewer indentations 795 than the scoring zone 750c representing the nine of hearts.

Game system 70 may include features of other game systems as disclosed herein.

For example, in some embodiments, game system 70 may comprise a playing card rank indicator illumination source 200 for illuminating the playing card rank indicators 780. The playing card rank indicator illumination source 200 may comprise a light source 210 and an electrical supply 220 for providing electricity to the light source 210. Game system 70 may comprise a playing card suit indicator illumination source 300 for back-lighting the playing card suit indicators 770. The playing card suit illumination source 300 may comprise a light source 310 and an electrical supply 320 for providing electricity to the light source 310.

In some embodiments, similar to that shown in FIG. 4, game system 70 comprises one or more display units 400 for displaying the distinct resting areas 750 on the top surface 730 of the mat 700. Such embodiments may further include one or more processors 500 for controlling the display unit(s) 400. The processor(s) 500 may be in communication with the one or more display units 400 wirelessly (not shown) or through wired connections 510a, 510b, as shown in FIG. 4. Regardless of the type of connectivity, the processor(s) 500 may be housed within the mat 700, similar to the configuration shown in FIG. 4, or as a separate unit from the mat 700 (not shown).

Referring now to FIG. 8, a game system 80 for playing a card game on a vertical surface according to the present disclosure comprises a target board 800 subdivided into a plurality of target zones 850/855. The target zones may include scoring zones 850 and optionally wild card zones 855. The target board 800 includes a hook-and-loop fastener layer on a front-facing surface of the target board. The hook-and-loop fastener adheres to a ball including a complementary hook-and-loop outer surface. In some embodiments, each of the scoring zones 850 comprises a playing card suit indicator 870 and a playing card rank indicator 880. The target zones 850/855 may be separated from each other visually by borders 890. Unlike the ridges 190/790 described above, borders 890 for game system 80 do not protrude significantly from the surface of the target board 800 in some embodiments. Alternatively, borders 890 may protrude from the front-facing surface of the target board 800 in other embodiments.

In some embodiments, the game system 80 can be used to play a card game on a non-vertical (e.g., horizontal or substantially horizontal) surface. For example, the target board 800 may be placed on a non-vertical (e.g., horizontal or substantially horizontal) surface and used in a similar manner to game system 10, game system 12, game system 20, or game system 70.

Referring now to FIG. 9, a game system according to the present disclosure may further comprise a golf mat 820 for placing on a non-vertical surface F and for placing a hook-and-loop covered golf ball thereupon. The golf mat 820 may comprise an artificial turf material, such as a GB-006 nylon putting turf (Southwest Greens, Dalton Ga.) or a polyurethane artificial turf carpet (e.g., Putt Putt Pro putting green turf, Georgia Carpet Industries, Dalton Ga.). In other embodiments, the golf mat 820 comprises a woven fiber (e.g., wool, nylon, viscose, polyurethane, jute, viscose, coir, mountain grass, seagrass, sisal, or tencel) carpet.

The golf mat 820 may include origin spots 860 similar to origin spots 160 described above with respect to game system 10. In such embodiments, the target board 800 may be mounted on a vertical surface W and the hook-and-loop covered golf ball may be hit, tossed, launched, or struck by a player from the golf mat 820 towards the target board 800. The target board 800 and/or the golf mat 820 may be flexible to facilitate convenient storage and/or transport.

In other embodiments, the ball has a size consistent with a table tennis ball and can be thrown, bounced or hit towards the target board 800.

Accordingly, a golf apparatus 10 according to the present disclosure comprises a mat 100 comprising a proximal end 110, a distal end 120, a top side 130 and a bottom side 140; a plurality of distinct resting areas 150 near the distal end 120; and at least one origin spot 160 near the proximal end 110 for placing a golf ball. In some embodiments, the resting areas 150 each comprise a playing card suit indicator 170 and a playing card rank indicator 180. In some embodiments, each of the resting areas 150 represents a unique combination of a playing card suit indicator 170 and a playing card rank indicator 180. In some embodiments, the golf apparatus 10 comprises at least 13 distinct resting areas 150. In some embodiments, the golf apparatus 10 comprises at least 26 distinct resting areas 150. In some embodiments, the golf apparatus 10 comprises at least 52 distinct resting areas 150. In some embodiments, the golf apparatus 10 comprises at least two origin spots 160. In some embodiments, the golf apparatus 10 comprises at least three origin spots 160. In some embodiments, the golf apparatus 10 further comprises a slope extending from at or near the proximal end 110 upwards towards the distal end 120. In some embodiments, the golf apparatus 10 further comprises a slope extending from at or near the proximal end 110 downwards towards the distal end 120. In some embodiments, the proximal end 110 is at a lower elevation than the distal end 120. In some embodiments, the golf apparatus 10 further comprises a ridge 190 protruding upwards from the top side 130 of the mat 100 between each distinct resting area 150. In some embodiments, the golf apparatus 10 further comprises a ridge 190 outlining each playing card suit indicator 170 and protruding upwards from the top side 130 of the mat 100. In some embodiments, the golf apparatus 10 further comprises a ridge 190 outlining each playing card rank indicator 180 and protruding upwards from the top side 130 of the mat 100. In some embodiments, the top side 130 of the mat 100 comprises a texture. In some embodiments, the texture simulates a putting green texture. In some embodiments, the golf apparatus 10 is flexible. In some embodiments, the plurality of distinct resting areas 150 can be rearranged mechanically or electronically; manually or automatically, on the top surface 130 of the mat 100. In some embodiments, the golf apparatus 10 further comprises at least one playing card suit indicator illumination element 300 for illuminating at least one playing card suit indicator 170. In some embodiments, the golf apparatus 10 further comprises at least one playing card rank indicator illumination element 200 for illuminating at least one playing card rank indicator 180. In some embodiments, at least one of the distinct resting areas 150 represents a wild card 155. In some embodiments, the golf apparatus 10 further comprises a first display unit 400 for displaying the playing card suit indicators 170 and the playing card rank indicators 180 at the top surface 130 of the mat 100. In some embodiments, the first display unit 400 is in communication with a processor 500 configured to display the playing card suit indicators 170 and the playing card rank indicators 180 at specific relative distinct resting area positions 150. In some embodiments, the processor 500 is configured to cause the first display unit 400 to display the playing card suit indicators 170 and the playing card rank indicators 180 at random relative distinct resting area positions 150. In some embodiments, the processor 500 is configured to cause the first display unit 400 to display the playing card suit indicators 170 and the playing card rank indicators 180 at specific relative resting area positions 150 representing a pattern associated with a handicap score. In some embodiments, the handicap score is associated with a golf handicap score associated with a player. In some embodiments, the golf apparatus further comprises an input device 600 for inputting the golf handicap score associated with the player. In some embodiments, the processor 500 is configured to cause the first display unit 400 to display the playing card suit indicators 170 and the playing card rank indicators 180 at specific relative resting area positions 150 representing a first pattern associated with a first handicap score, and to display the playing card suit indicators 170 and the playing card rank indicators 180 at specific relative resting area positions 150 representing a second pattern associated with a second handicap score. In some embodiments, the first handicap score is lower than the second handicap score, and the first pattern comprises relatively more playing card rank values 180 of high rank in distinct resting areas 150 near the distal end 120 of the mat compared to the second pattern. In some embodiments, the golf apparatus 10 further comprises a second display unit 650 for displaying game play information. In some embodiments, the game play information comprises at least one of: player identification information, player handicap information, player score, resting area suit and rank data associated with a player's previous actions, statistical odds of achieving one or more specified collections of resting area suits and ranks (e.g., statistical odds of scoring one or more desirable poker hands), an instruction for enabling further game play, and a score associated with one or more opponent players. In some embodiments, the processor is configured to enable game play between two or more players interacting through a data network. In some embodiments, the data network comprises the world wide web. In some embodiments, a size of each resting area 150 is inversely proportional to the playing card rank indicator 180 displayed in that resting area. In some embodiments, a size of each resting area 150 is adjusted by the processor 500 based at least in part on a combination of a first playing card suit 170 and a first playing card rank 180 associated with a first resting area 150 into which a player delivers a first golf ball during a first game play action. In some embodiments, a size of one or more resting areas 150 associated with a highly desirable playing card suit 170 and/or a highly desirable playing card rank 180 is reduced by the processor 500, and/or wherein a size of one or more resting areas 150 associated with a highly undesirable playing card suit 170 and/or a highly undesirable playing card rank 180 is increased by the processor 500. In some embodiments, the size of one or more resting areas 150 associated with a highly desirable playing card suit 170 and/or a highly desirable playing card rank 180 is reduced by the processor 500, and wherein a size of one or more resting areas 150 associated with a highly undesirable playing card suit 170 and/or a highly undesirable playing card rank 180 is increased by the processor 500. In some embodiments, the resting areas 150 associated with a highly desirable playing card suit 170 and/or a highly desirable playing card rank 180 are those that, in combination with the first playing card suit 170 and the first playing card rank 180 associated with the first resting area 150 into which a player delivers the first golf ball during the first game play action, would increase the player's odds of achieving a series of resting areas 150 associated with a poker hand of high relative rank. In some embodiments, the poker hand of high relative rank is selected from the group consisting of: royal flush, straight flush, four of a kind, full house, flush, straight, and three of a kind.

In some embodiments, the poker hand of high relative rank is selected from the group consisting of: royal flush, straight flush, four of a kind, full house, and flush. In other embodiments, the poker hand of high relative rank is selected from the group consisting of: royal flush, straight flush, and four of a kind.

In other embodiments, a device 70 for playing a card game according to the present disclosure comprises a mat 700 comprising a top surface 730 including a proximal zone 710 and a distal zone 720; a plurality of scoring zones 750 within the distal zone 720; and at least one player action area 760 within the proximal zone 710, wherein each of the scoring zones 750 corresponds to a combination of one playing card suit 770 and one playing card rank 780. In some embodiments, each of the scoring zones 750 comprises a playing card suit indicator 770 and a playing card rank indicator 780. In some embodiments, the device 70 further comprises at least one wild card zone 755 within the distal zone 720, wherein the at least one wild card zone 755 represents a wild card. In some embodiments, the at least one player action area 760 comprises at least one location for placing a golf ball to be struck by a player. In some embodiments, the distal area 720 comprises a plurality of indentations 795 for receiving a golf ball. In some embodiments, each of the plurality of indentations 795 is located within a single scoring zone 750 or within a single wild card zone 755. In some embodiments, the distal area 720 comprises a barrier 790 between each of the scoring zones. In some embodiments, at least one of the scoring zones 750 can be repositioned relative to at least one other scoring zone 750. In some embodiments, at least one wild card zone 755 can be repositioned relative to at least one other scoring zone 750 and/or relative to at least one other wild card zone 755. In some embodiments, the plurality of scoring zones 750 is secured within the distal zone 720 by hook-and-loop fastener. In some embodiments, the plurality of scoring zones 750 comprises a magnet, and wherein the distal zone 720 comprises a magnet for securing the plurality of scoring zones 750 to the distal zone 720 by magnetism.

In other embodiments, a device 80 for playing a game on a vertical surface W according to the present disclosure comprises a target board 800 subdivided into a plurality of target zones 850/855; and a first hook-and-loop fastener layer on a front-facing surface of the target board 800 for adhering to a ball including a second hook-and-loop fastener that is complimentary to the first hook-and-loop fastener. In some embodiments, the plurality of target zones 850/855 comprises scoring zones 850 and optionally wild card zones 855. In some embodiments, each of the scoring zones 850 comprises a playing card suit indicator 870 and a playing card rank indicator 880. In some embodiments, the ball has a size and weight consistent with a golf ball. In other embodiments, the ball has a size consistent with a table tennis ball. In some embodiments, the device further comprises a golf mat 820 for placing on a non-vertical surface F and for placing the ball thereupon.

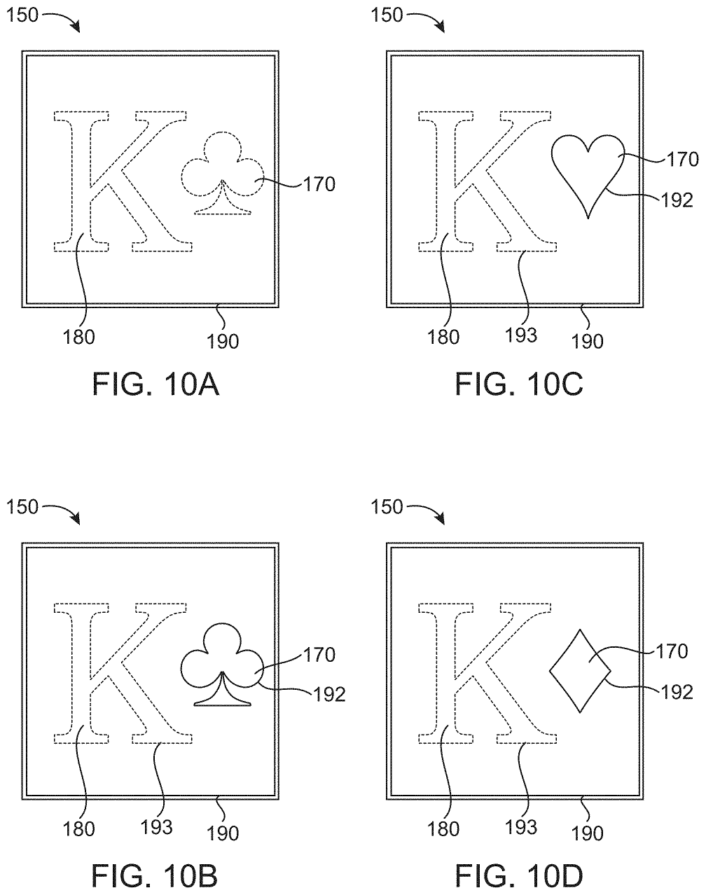

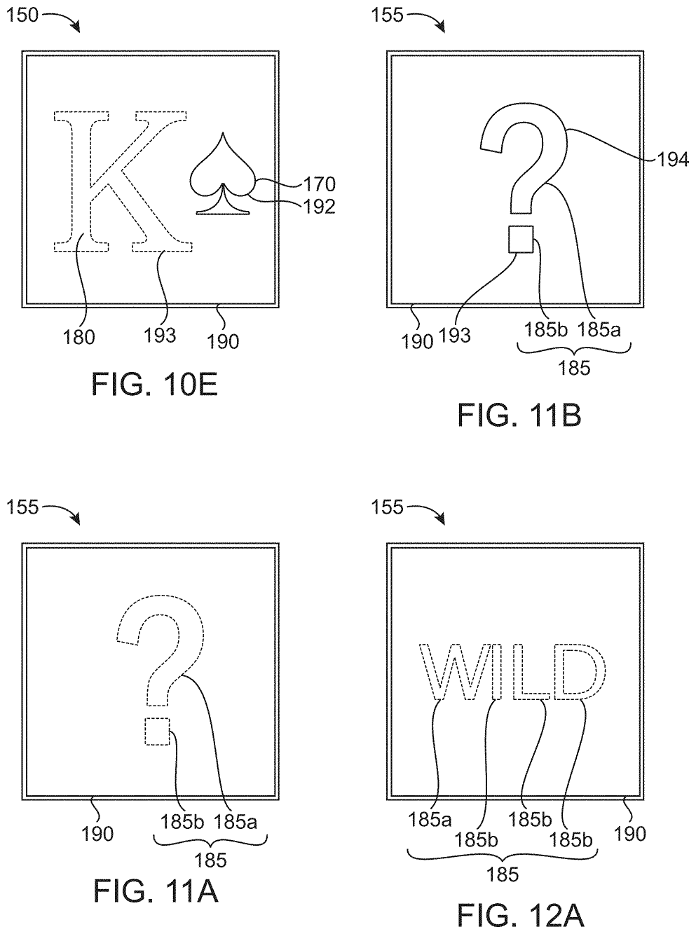

FIGS. 10A-10E show exemplary designs for distinct resting areas 150/750/850. In general, each distinct resting area comprises a shape defined by a border 190. In some embodiments, the border 190 comprises a ridge such as ridge 190 described above. In other embodiments, the border 190 does not include a ridge 190. The distinct resting areas 150/750/850 further comprise a playing card suit indicator 170. The playing card suit indicator 170 shown in FIG. 10B represents the playing card suit of clubs. The playing card suit indicator 170 shown in FIG. 10C represents the playing card suit of hearts. The playing card suit indicator 170 shown in FIG. 10D represents the playing card suit of diamonds, while the playing card suit indicator 170 shown in FIG. 10E represents the playing card suit of spades. In some embodiments, the playing card suit indicator 170 comprises a border 192, which in some embodiments may be raised relative to the surface of the distinct resting area 150/750/850. Like the one or more ridges 190 described in greater detail above, the border 192 may comprise a polymeric material, paint, and/or relatively higher pile carpet fibers.

Each distinct resting area 150/750/850 further comprises a playing card rank indicator 180. The playing card rank indicators 180 are shown in broken lines in FIGS. 10A-10E for convenience; one of ordinary skill will readily recognize that, like a deck of playing cards, the playing card rank indicator 180 featured in each distinct resting area 150/750/850 may be any one of numbers 2-10, a jack, a queen, a king, or an ace.

Each playing card rank indicator 180 may include a border 193 which in some embodiments may include a ridge similar to ridge 190 described in greater detail above. For example, border 193 may be raised relative to the surface of the distinct resting area 150/750/850. In some embodiments, the border 193 may comprise a polymeric material, paint, and/or relatively higher pile carpet fibers, consistent with the one or more ridges 190 described in greater detail above.

Referring now to FIGS. 11A-11B, wild card areas 155/755/855 may comprise a border 190 and a wild card indicator 185. The border 190 may be configured consistent with the one or more ridges 190 described in greater detail above. For example, the border 190 may in some embodiments comprise a polymeric material, paint, and/or relatively higher pile carpet fibers. In some embodiments, the wild card areas 155/755/855 do not include a wild card indicator 185. In some embodiments, the wild card areas 155/755/855 do not include a border 190. In some embodiments, the wild card areas 155/755/855 do not include a wild card indicator 185 or a border 190 (e.g., the wild card areas 155/755/855 are blank spaces).

The wild card indicator 185 may comprise two distinct areas 185a, 185b. In the example shown in FIGS. 11A-11B, the wild card indicator 185 comprises a question mark symbol consisting of a curved portion 185a and a spot portion 185b. Each of the curved portion 185a and the spot portion 185b may comprise a border 194. While a question mark symbol is shown in FIGS. 11A-11B, other symbols may be employed instead, such as an exclamation point, or an asterisk. The border 194 may be configured consistent with the one or more ridges 190 described in greater detail above. For example, the border 194 may in some embodiments comprise a polymeric material, paint, and/or relatively higher pile carpet fibers.

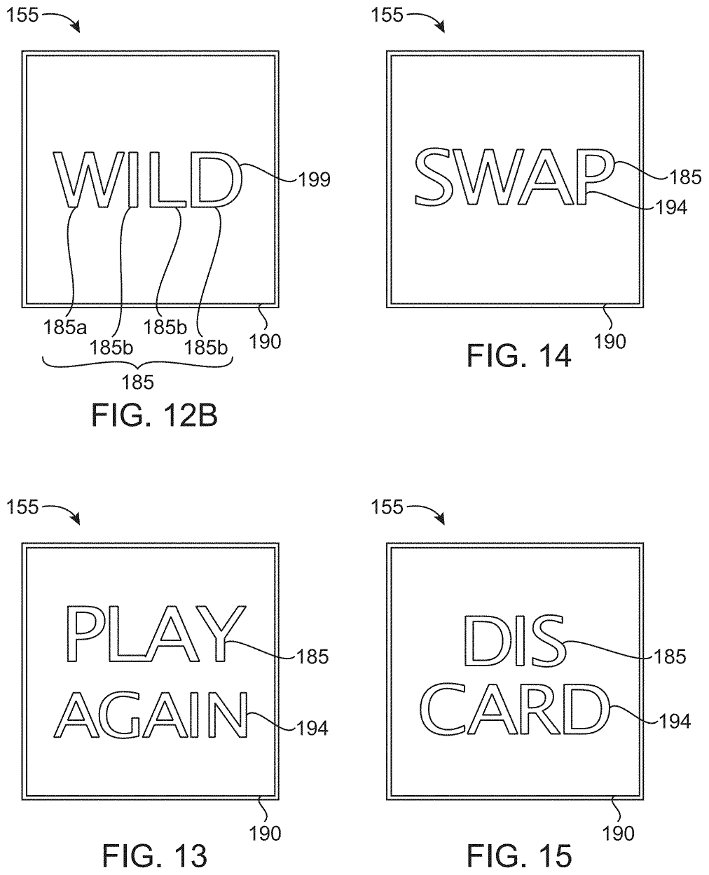

Referring now to FIGS. 12A-12B, wild card areas 155/755/855 may comprise a border 190 and a wild card indicator 185. The border 190 may be configured consistent with the one or more ridges 190 described in greater detail above. For example, the border 190 may in some embodiments comprise a polymeric material, paint, and/or relatively higher pile carpet fibers.

The wild card indicator 185 may comprise a plurality of distinct areas. In the example shown in FIGS. 12A-12B, the wild card indicator 185 comprises a series of letters 185a, 185b, 185c, and 185d that form the word “WILD.” One of ordinary skill in the art will readily recognize, however, that other words may be formed to represent a wild card area 155/755/855, such as “WC” or “W.C.”. Each of the letters 185a-185d may comprise a border 194 in some embodiments. The border 194 may be configured consistent with the one or more ridges 190 described in greater detail above. For example, the border 194 may in some embodiments comprise a polymeric material, paint, and/or relatively higher pile carpet fibers.

FIGS. 13-16 illustrate exemplary wild card areas 155/755/855 featuring specific game play instructions. Each wild card area 155 may comprise a border 190 and a game play instruction indicator 185. The border 190 may be configured consistent with the one or more ridges 190 described in greater detail above. For example, the border 190 may in some embodiments comprise a polymeric material, paint, and/or relatively higher pile carpet fibers.

Each game play instruction indicator 185 may comprise one or more letters and/or symbols that, in combination, correspond to a game play instruction. For example, as shown in FIG. 13, the game play instruction indicator 185 comprises a series of letters that spell the instruction “PLAY AGAIN.” During game play, a player who causes a projectile to come to rest on the wild card area 155/755/855 including the game play instruction indicator 185 “PLAY AGAIN” may be instructed to cause a second projectile to be propelled towards one or more distinct resting areas 150 and/or one or more wild card areas 155/755/855 (e.g., a “do over” type of instruction).

As shown in FIG. 14, another wild card area 155/755/855 comprises a game play instruction indicator 185 including a series of letters that spell the instruction “SWAP.” During game play, a player who causes a projectile to come to rest on the wild card area 155/755/855 including the game play instruction indicator 185 “SWAP” may be instructed to trade one or more playing cards in his/her collection with another player.

FIG. 15 shows another exemplary wild card area 155/755/855 including a game play instruction indicator 185 that spells the word “DISCARD.” During game play, a player who causes a projectile to come to rest on the wild card area 155/755/855 including the game play instruction indicator 185 “DISCARD” may be instructed to delete a playing card from his/her collection, leaving the player with one fewer card in his/her collection than the maximum possible number of cards enabled by ordinary game play. Alternatively, a player who causes a projectile to come to rest on the wild card area 155/755/855 including the game play instruction indicator 185 “DISCARD” may be instructed to delete a playing card from his/her collection and then to cause another projectile to be propelled towards one or more distinct resting areas 150 and/or one or more wild card areas 155/755/855.

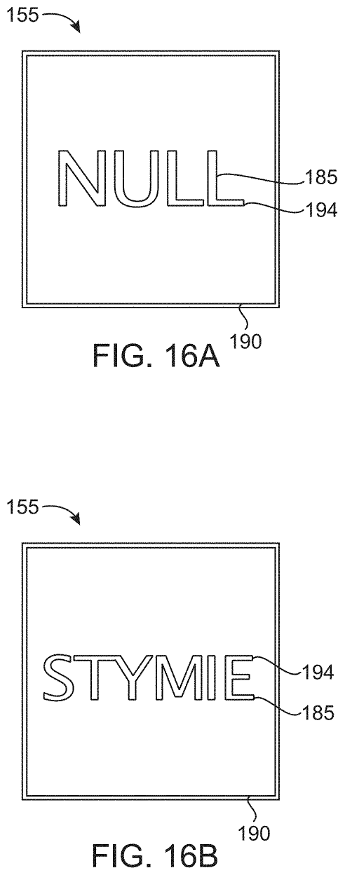

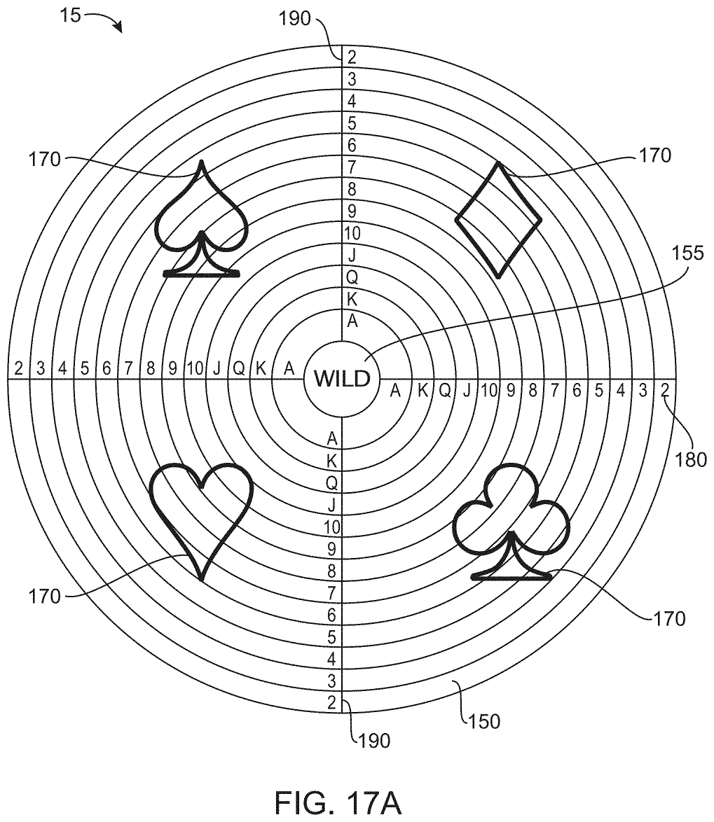

Another exemplary wild card area 155/755/855 is shown in FIG. 16A, this one including a series of letters that spells the word “NULL.” During game play, a player who causes a projectile to come to rest on the wild card area 155/755/855 including the game play instruction indicator 185 “NULL” may be awarded no playing card or other game play feature. Such a wild card area 155/755/855 may thus correspond to a lost opportunity to collect a playing card. If the game to be played is 5-card stud poker, for example, a player who causes one projectile to come to rest on a wild card area 155/755/855 including the game play instruction indicator 185 “NULL” may therefore only collect four playing cards during the round of game play.

Yet another exemplary wild card area 155/755/855 is shown in FIG. 16B, in which a series of letters spells the word “STYMIE.” During game play, a player who causes a projectile to come to rest on a wild card area 155/755/855 including the game play instruction indicator “STYMIE” may be awarded an opportunity to place a stymie device 3000/3100/3200, described in further detail below, on one or more distinct resting area 150, scoring zone 750/850, wild card 155, and/or wild card area 755/855.

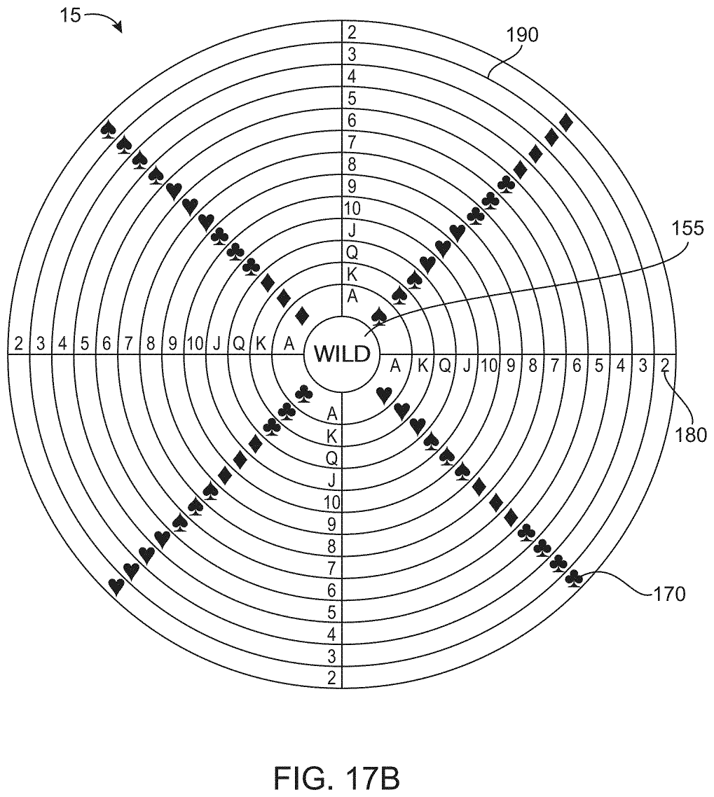

Referring now generally to FIGS. 17A-17B, the present disclosure provides a target area 15 comprising distinct resting areas 150 and at least one wild card area 155. The distinct resting areas 150 and the at least one wild card area 155 may be separated from each other by borders 190, which may extend above the surface of the distinct resting areas and/or the at least one wild card area 155.

In the embodiment shown in FIG. 17A, one wild card area 155 is surrounded by distinct resting areas 150. In some embodiments, the one wild card area 155 may be substantially coplanar with the distinct resting areas 150. In other embodiments, the one wild card area 155 may not be substantially coplanar; for example, in some embodiments, the one wild card area 155 may be represented by a golf cup. In some embodiments, the borders 190 comprise a polymeric material, such as rubber, polyethylene, polypropylene, or polycarbonate. In other embodiments, the one or more borders 190 are formed of paint. In other embodiments, the one or more borders 190 comprise carpet of a higher pile than surrounding areas. In other embodiments, the one or more borders 190 comprise a metallic material, such as brass, steel, iron, or aluminum. If the target area 15 is applied to a carpet or natural turf surface, for example to a putting green, the borders 190 may preferably comprise paint or chalk.

The distinct resting areas 150 shown in FIG. 17A each comprise a playing card rank indicator 180, which may be configured consistent with other embodiments disclosed herein. The target area 15 shown in FIG. 17A shows the distinct resting areas 150 arranged into quadrants of like playing card suits 170. Accordingly, each distinct resting area 150 does not necessarily include a playing card suit indicator 170. Instead, each quadrant may include a single playing card suit indicator 170, reducing the amount of paint or chalk and effort required to apply the target area 15 to a surface.

The distinct resting areas 150 are shown in FIG. 17A to be arranged in an ordered concentric pattern in which distinct resting areas 150 having relatively high rank values are closer to the central wild card area 155 than distinct resting areas 150 having relatively low rank values. Use of such embodiments, for example as a component of a golfer's putting practice, thus encourages and rewards a golfer who consistently advances golf balls to locations in close proximity to the central wild card area 155 (e.g., a golf cup).

In an alternate arrangement, shown in FIG. 17B, the distinct resting areas 150 are shown as ˜90° arcuate shapes arranged about a central wild card area 155, which may be a golf cup in some embodiments, but with the playing card suit indicators 170 shown in each distinct resting area 150. As shown in FIG. 17B, this configuration enables shuffling of the playing card suits within each quadrant. Although distinct resting areas 150 including a relatively high playing card rank indicator 180 are shown to be in closer proximity to the central wild card area 155 than distinct resting areas 150 including a relatively low playing card rank indicator 180, one of ordinary skill in the art will recognize that other arrangements of the distinct resting areas 150 are possible without deviating from the scope of this disclosure.

Similarly, while the concentrically arranged embodiments shown in FIGS. 17A-17B illustrate only a single central wild card area 155, other embodiments may include additional types of wild card areas 155 as described herein, such as wild card areas 155 shown in FIGS. 11A-12B, “play again” instructional wild card area 155 shown in FIG. 13, “swap” instructional wild card area 155 shown in FIG. 14, “discard” instructional wild card area 155 shown in FIG. 15, “null” instructional wild card area 155 shown in FIG. 16A, and/or “stymie” instructional wild card area 155 shown in FIG. 16B.

While the distinct resting areas 150 shown in FIGS. 17A-17B are represented by 90° arcuate shapes, other shapes may be used instead to provide a similar organized pattern of distinct resting areas 150 that reward a player for consistently propelling a projectile to a position in close proximity to a central target such as a central wild card area 155 (e.g., a golf cup). For example, the overall shape of the target area 15 may be rectangular, with each distinct resting area 150 represented by a quadrilateral (e.g., rectangular or trapezoidal) shape.

Use of a target area 15 consistent with FIG. 17 in some embodiments enables players to propel projectiles towards the target area 15 from multiple angles, in some instances from any angle surrounding the target area 15. Such embodiments therefore allow players to use the same target area 15 while avoiding severe (or permanent) damage to locations designated as origin spots, such as are shown in FIGS. 1A-1B. Accordingly, embodiments consistent with target area 15 as shown in FIG. 17 are particularly suitable for use on surfaces that are prone to wear and tear, such as natural turf surfaces like putting greens.

In some embodiments, the present disclosure provides a sports training apparatus comprising: a mat comprising a proximal end, a distal end, a top side and a bottom side; a plurality of distinct resting areas on the top side and near the distal end; a raised ridge on the top side between each of the distinct resting areas; and at least one origin spot on the top side and near the proximal end for placing a ball. In some embodiments, the distinct resting areas each comprise a playing card suit indicator and a playing card rank indicator, represents a wild card, or represents a player action instruction. In some embodiments, each of the distinct resting areas comprising a playing card suit indicator and a playing card rank indicator represents a unique combination of a playing card suit indicator and a playing card rank indicator. In some embodiments, the sports training apparatus comprises at least 13 distinct resting areas. In some embodiments, the sports training apparatus comprises at least 26 distinct resting areas. In some embodiments, the sports training apparatus comprises 52 distinct resting areas. In some embodiments, the sports training apparatus comprises 56 distinct resting areas. In some embodiments, the sports training apparatus comprises 64 distinct resting areas. In some embodiments, the sports training apparatus comprises at least two origin spots. In some embodiments, the sports training apparatus comprises at least three origin spots. In some embodiments, the sports training apparatus further comprises a slope extending from at or near the proximal end upwards towards the distal end. In some embodiments, the sports training apparatus further comprises a slope extending from at or near the proximal end downwards towards the distal end. In some embodiments, the proximal end is at a lower elevation than the distal end. In some embodiments, the raised ridge comprises a continuous ridge. In some embodiments, the raised ridge comprises a plurality of raised ridge segments. In some embodiments, each of the ridge segments has a circular topographical shape. In some embodiments, each of the ridge segments has an oblong topographical shape. In some embodiments, the top side has a surface stimp rating of about 7 to about 14, such as about 7, about 8, about 9, about 10, about 11, about 12, about 13, or about 14. In some embodiments, the top side has a surface stimp rating of about 11. In some embodiments, the sports training apparatus is flexible. In some embodiments, less than about 1% of the raised ridges dissociate from the golf apparatus when the sports training apparatus is rolled into a cylindrical shape. In some embodiments, at least one of the distinct resting areas represents a wild card. In some embodiments, the raised ridge protrudes from the top side of the sports training apparatus by at least about 0.15 mm and by not more than about 0.6 mm, such as at least about 0.15 mm, at least about 0.16 mm, at least about 0.17 mm, at least about 0.18 mm, at least about 0.19 mm, at least about 0.2 mm, at least about 0.21 mm, at least about 0.22 mm, at least about 0.23 mm, at least about 0.24 mm, at least about 0.25 mm, at least about 0.26 mm, at least about 0.27 mm, at least about 0.28 mm, at least about 0.29 mm, at least about 0.3 mm, at least about 0.31 mm, at least about 0.32 mm, at least about 0.33 mm, at least about 0.34 mm, at least about 0.35 mm, at least about 0.36 mm, at least about 0.37 mm, at least about 0.38 mm, at least about 0.39 mm, at least about 0.4 mm, at least about 0.41 mm, at least about 0.42 mm, at least about 0.43 mm, at least about 0.44 mm, at least about 0.45 mm, at least about 0.46 mm, at least about 0.47 mm, at least about 0.48 mm, at least about 0.49 mm, at least about 0.5 mm, at least about 0.51 mm, at least about 0.52 mm, at least about 0.53 mm, at least about 0.54 mm, at least about 0.55 mm, at least about 0.56 mm, at least about 0.57 mm, at least about 0.58 mm, at least about 0.59 mm, or at least about 0.6 mm. In some embodiments, each ridge segment protrudes from the top side of the sports training apparatus by at least about 0.15 mm and by not more than about 0.6 mm, and wherein each ridge segment has a diameter of at least about 1 mm and not more than about 4 mm, for example about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, about 3.6 mm, about 3.7 mm, about 3.8 mm, about 3.9 mm, or about 4 mm. In some embodiments, each ridge segment protrudes from the top side of the sports training apparatus by about 0.4 mm and has a diameter of about 2.5 mm. In some embodiments, the sports training apparatus comprises a graphic element on the top side between the at least one origin spot and the plurality of distinct resting areas near the distal end. In some embodiments, the ball is a golf ball.

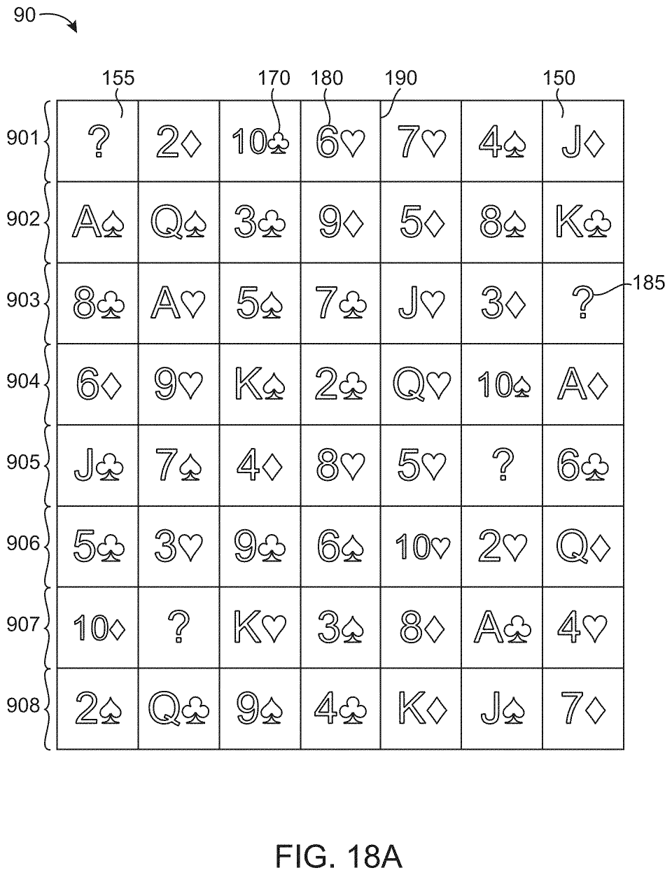

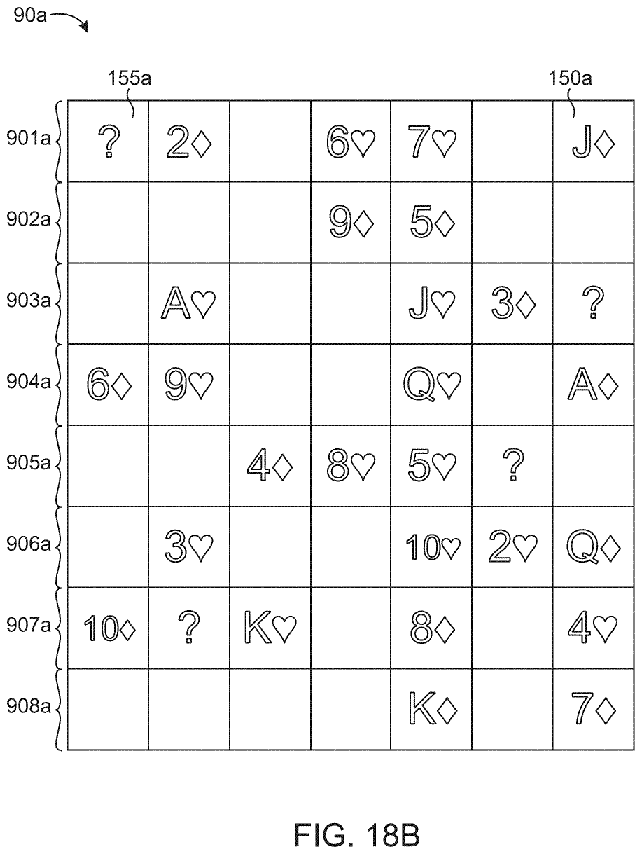

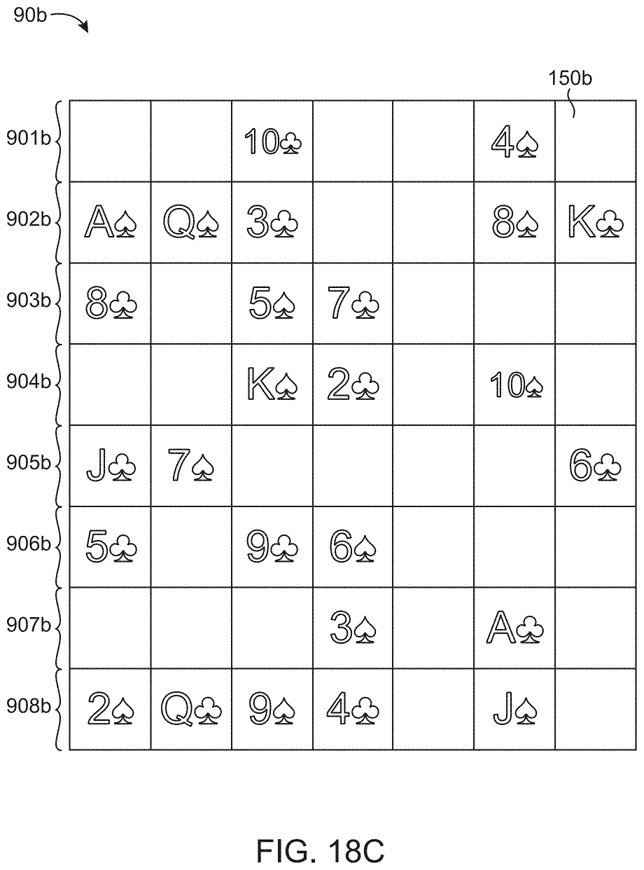

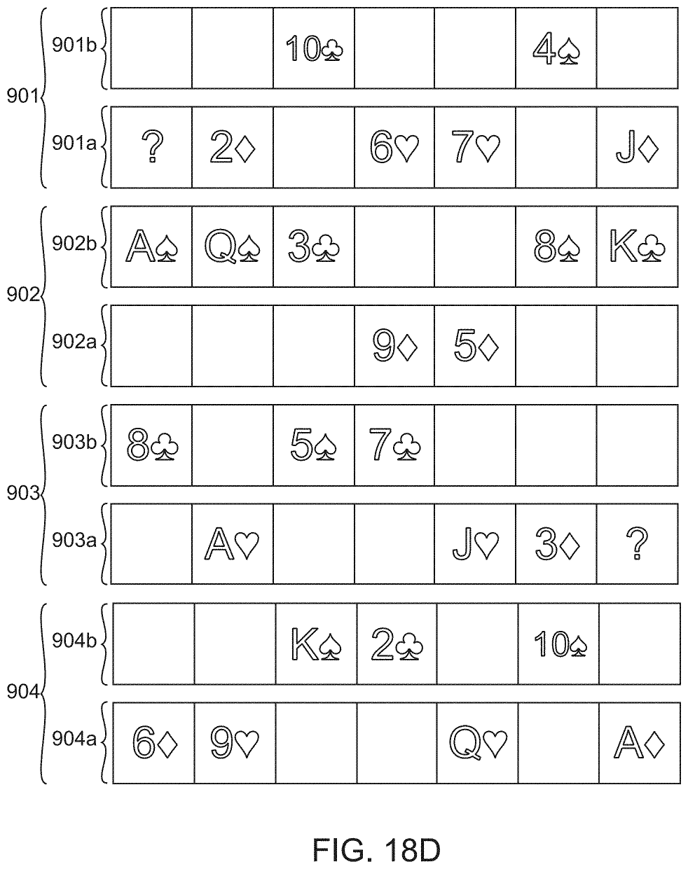

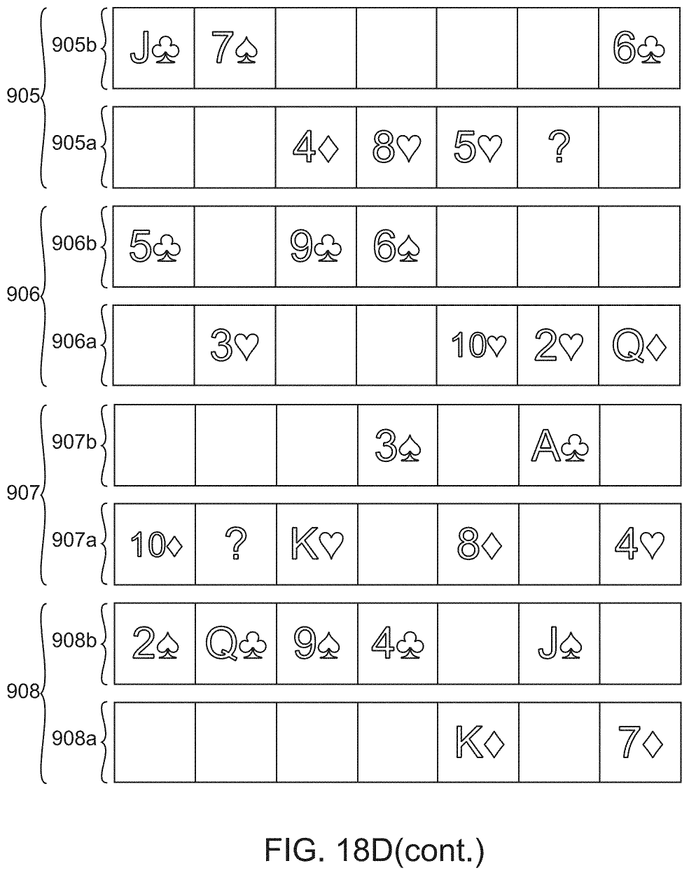

As shown in FIGS. 18A-18D, the present disclosure further provides one or more stencils 90 for creating a pattern of distinct resting areas 150/750/850 and wild card areas 155/755/855. The one or more stencils 90 may comprise a series of playing card suit indicator voids 170, playing card rank indicator voids 180, wild card indicator voids 185, and/or border voids 190, through which paint may be applied to a surface. The surface may be any surface that can accept an applied paint, such as wood, metal, concrete, asphalt, grass, sand, dirt, or a combination of any two or more of the foregoing.

In the exemplary embodiment shown in FIGS. 18A-18D, the one or more stencils 90 are divided into eight rows 901-908, each row including a total of seven distinct resting areas 150 and wild card areas 155.

In some embodiments, only one stencil 90 is used to create a pattern of distinct resting areas 150 and wild card areas 155. If paint is used with the one stencil 90, one color of paint may be used. Alternatively, more than one color of paint may be used, with the user choosing one color of paint for each distinct resting area 150 and for each wild card area 155. For example, a user may use red paint (e.g., red spray paint) to paint the distinct resting areas 150 including playing card suit indicators 170 corresponding to hearts and diamonds, and black or white paint (e.g., black or white spray paint) to paint the distinct resting areas 150 including playing card suit indicators 170 corresponding to clubs and spades. The user may use red, black, white, or another color of paint to paint the wild card areas 155, as desired.

Alternatively, as shown in FIGS. 18B-18C, the one or more stencil 90 may be divided into two complementary stencils 90a-90b, one to be used with a first color of paint (e.g., red paint with stencil 90a shown in FIG. 18B to create red colored distinct resting areas 150a and red colored wild card areas 155a), and the second to be used with a second color of paint (e.g., black paint with stencil 90b shown in FIG. 18C to create black colored distinct resting areas 155b). Accordingly, one stencil 90a comprises one or more rows 901a-908a including distinct resting areas 150a corresponding to hearts and diamonds, while a second stencil 90b comprises one or more rows 901b-908b including distinct resting areas 150b corresponding to clubs and spades. FIG. 18B shows that stencil 90a includes wild card areas 155a. However, wild card areas 150a may alternatively, or in addition, be included on stencil 90b shown in FIG. 18C.

In another embodiment, the one or more stencil 90 may comprise more than two complementary stencils. For example, as shown in FIG. 18D, a set of 16 complementary stencils 901a-908b allows creation of over 40,000 unique arrangements of distinct resting areas 150 and wild card areas 155. In the exemplary embodiment shown in FIG. 18D, each row 901-908 comprises a complementary pair of black playing card rows 901b-908b and red playing card rows 901a-908a. A user may, for example, arrange each of the rows 901a-908a to be colored a first color (e.g., red), and may then apply the first color (e.g., red) through the voids in the stencils 901a-908a. Thereafter, the user may then arrange each of the complementary rows 901b-908b on top of the first applied color and may then apply the second color (e.g., black or white) through the voids in the stencils 901b-908b.

In some embodiments, a kit comprises at least one stencil 90 as disclosed herein and at least one container of paint (e.g., spray paint). In some embodiments, the kit comprises a pair of complementary stencils 90a-90b, a first container of paint having a first color, and a second container of paint having a second color. In some embodiments, the kit comprises more than one pair of complementary stencils, a first container of paint having a first color, and a second container of paint having a second color. In some embodiments, the more than one pair of complementary stencils comprises two pairs of complementary stencils. In other embodiments, the more than one pair of complementary stencils comprises three pairs of complementary stencils. In other embodiments, the more than one pair of complementary stencils comprises four pairs of complementary stencils. In other embodiments, the more than one pair of complementary stencils comprises five pairs of complementary stencils. In other embodiments, the more than one pair of complementary stencils comprises six pairs of complementary stencils. In other embodiments, the more than one pair of complementary stencils comprises seven pairs of complementary stencils. In other embodiments, the more than one pair of complementary stencils comprises eight pairs of complementary stencils. In other embodiments, the more than one pair of complementary stencils comprises nine pairs of complementary stencils. In other embodiments, the more than one pair of complementary stencils comprises ten pairs of complementary stencils. In other embodiments, the more than one pair of complementary stencils comprises eleven pairs of complementary stencils. In other embodiments, the more than one pair of complementary stencils comprises twelve pairs of complementary stencils.

Any kit embodiment disclosed herein may further comprise one or more stymie devices 3000/3100/3200 as disclosed herein.

In other embodiments, the present disclosure provides a plurality of golfing targets each comprising a different arrangement of distinct resting areas 150/scoring zones 750/850 and optionally wild card area(s) 155/wild card zones 755/855. For example, a mini golf course comprising nine holes may comprise nine unique arrangements of distinct resting areas 150/scoring zones 750/850 and optional wild card areas 155/wild card areas 755/855. By playing through each hole of the mini golf course, each player may collect up to nine playing cards corresponding to the resting locations of nine putted golf balls (one putted golf ball per mini golf hole per player). The player with the highest ranking collection of playing cards wins the match.

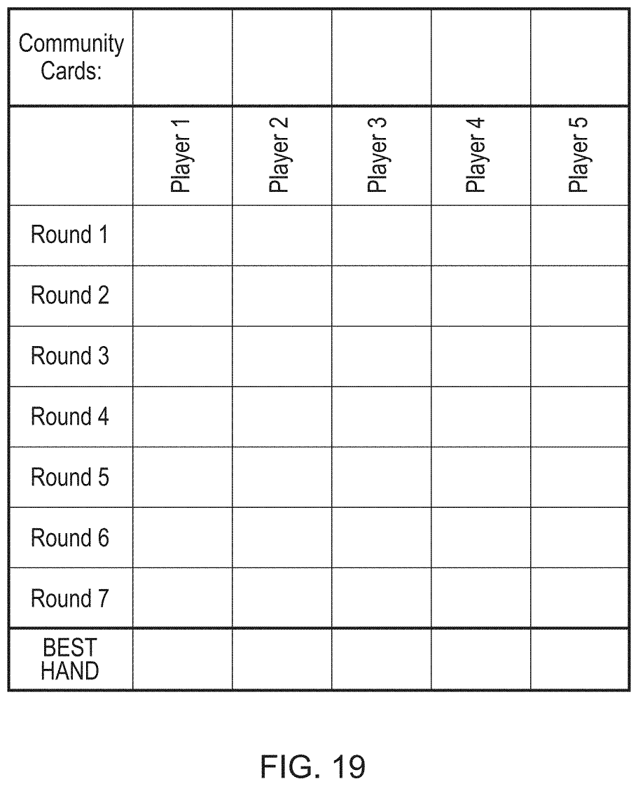

Any embodiment disclosed herein may further comprise a scorecard, such as the example scorecard 1000 shown in FIG. 19, for recording results of iterative game play.

In some embodiments, the scorecard 1000 is a physical scorecard for use with a writing instrument (not shown). In other embodiments, the scorecard 1000 is a computer rendered scorecard for use in connection with electronic game play as described herein.

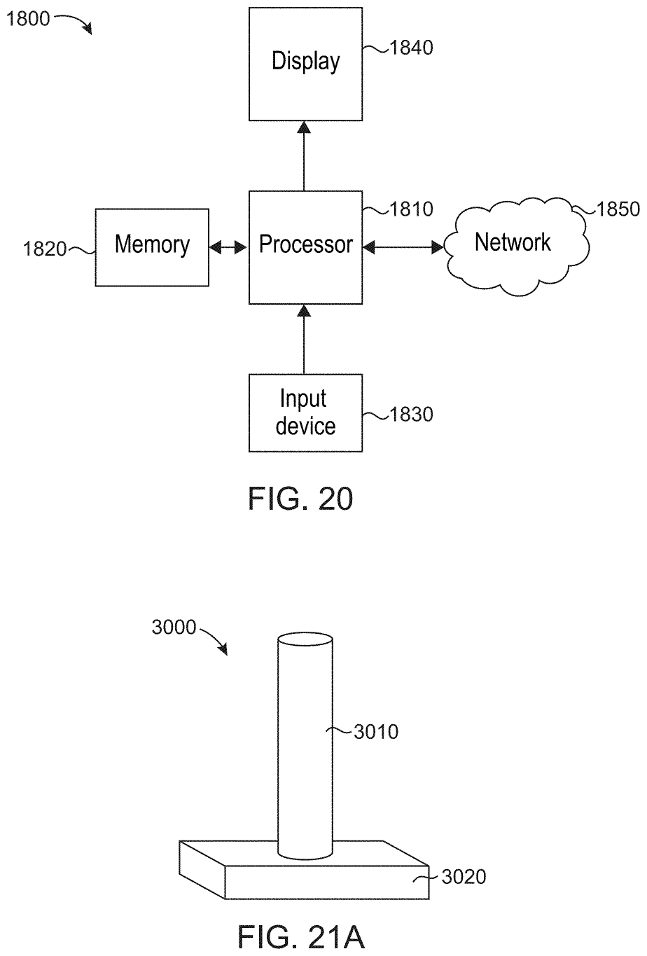

The present disclosure further provides a card game that may be played on an electronic game machine (e.g., an electronic dart machine or an electronic golf machine). In such embodiments, shown representatively in FIG. 20, an electronic game machine 1800 comprises a processor 1810 in operative communication with a memory 1820 which may store game play instructions. The processor 1810 may be in operative communication with an input device 1830, which in some embodiments may be a remote transponder, a track pad, a roller ball, a computer mouse, a motion sensor, or a video capture device. The input device 1830 receives game play signal(s) from a player. For example, in embodiments wherein the input device 1830 is a roller ball, a player causes the roller ball to spin, and the input device 1830 and the processor 1810 interpret the rotational speed and angle applied to the roller ball by the player to determine the flight path (e.g., direction and speed) of a ball rendered by the processor 1810. The processor 1810 is further in operative communication with a display 1840 for displaying game play and player prompts. In some embodiments, the electronic game machine 1800 is in operative communication with a network 1850, for example to allow multiple players to compete using multiple networked electronic game machines 1800.

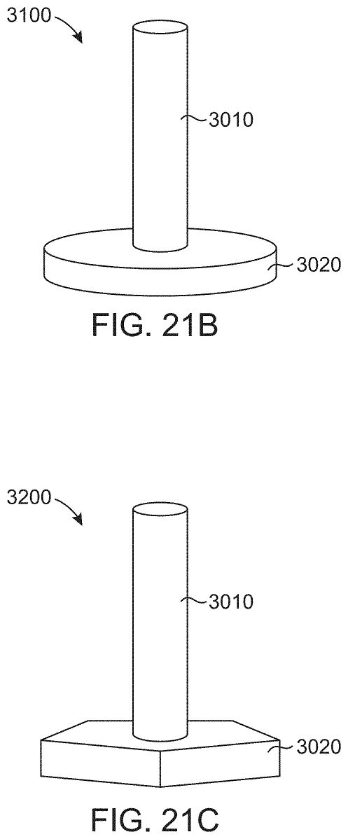

Referring now to FIGS. 21A-21C, the present disclosure provides a stymie device 3000, 3100, 3200 for use with a game apparatus as disclosed herein. The stymie device 3000, 3100, 3200 comprises a base 3020 and a handle 3010 attached to the base. The base 3020 may feature any suitable shape, such as a rectangle or square shown in FIG. 21A, a circle or oval as shown in FIG. 21B, or another polygon, such as the pentagon shown in FIG. 21C. In some embodiments, the stymie device 3000/3100/3200 does not include the handle 3010.

In some embodiments, the stymie device 3000/3100/3200 further comprises a magnet in or on the base 3020 for attachment of the stymie device 3000/3100/3200 to a magnetic surface, such as a game system 80 for use on a vertical or non-horizontal surface. In such embodiments, the mat 800 of the game system 80 comprises a magnetized surface or backing material to mate with the magnet of the stymie device 3000/3100/3200. In some embodiments, the stymie device 3000/3100/3200 includes a magnet in or on the base 3020 but does not include a handle 3010.

In some embodiments, the stymie device 3000/3100/3200 further comprises a first hook-and-loop fastener (e.g., VELCRO) on the bottom surface of the base 3020 for attachment of the stymie device 3000/3100/3200 to a surface that includes a second, complementary hook-and-loop fastener (e.g., VELCRO) material. In such embodiments, for example game system 80 for use on a vertical or non-horizontal surface, the surface 830 of the game system 80 comprises a second, complementary hook-and-loop fastener (e.g., VELCRO) material to mate with the first hook-and-loop fastener material of the stymie device 3000/3100/3200. In some embodiments, the stymie device 3000/3100/3200 includes the first hook-and-loop fastener (e.g., VELCRO) on the base 3020, but does not include a handle 3010.

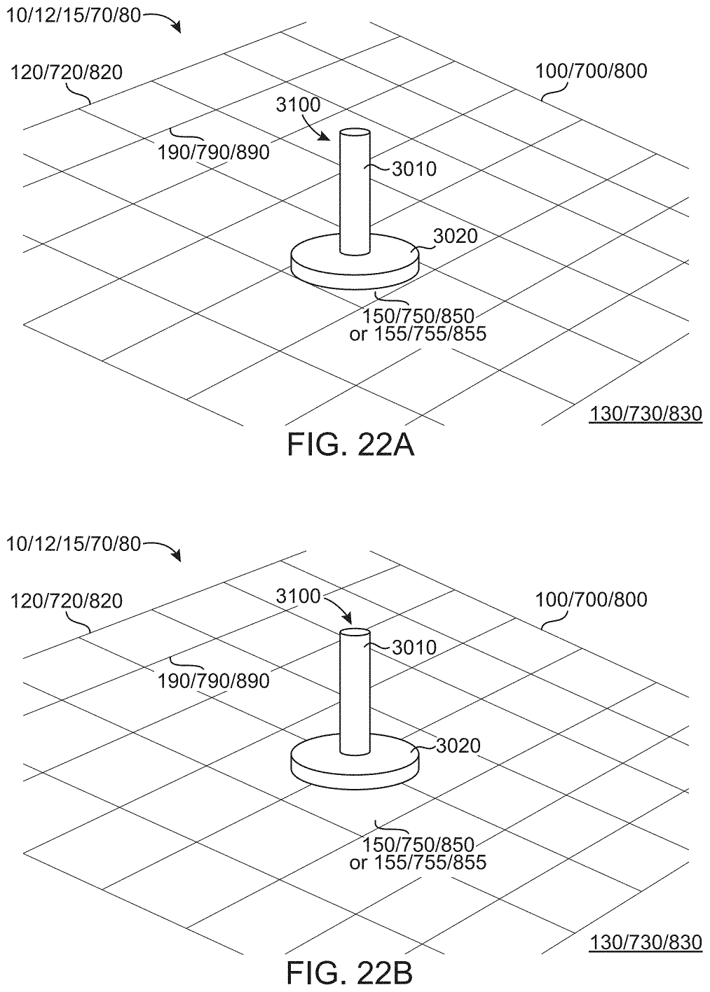

The stymie device 3000, 3100, 3200 in some embodiments is sized such that the base 3020 fits entirely within a single distinct resting area 150, a single scoring zone 750/850, a single wild card area 155, or a single wild card zone 755/855, for example as shown in FIG. 22A. In other embodiments, the stymie device 3000, 3100, 3200 may be sized to cover at least a portion of more than one distinct resting area 150, scoring zone 750/850, wild card area 155, or wild card zone 755/855, for example as shown in FIG. 22B.

In use, the stymie device 3000, 3100, 3200 may be placed on a single distinct resting area 150, scoring zone 750/850, wild card area 155, or wild card zone 755/855, for example as shown in FIG. 22A. In other embodiments, the stymie device 3000, 3100, 3200 may be placed on at least a portion of more than one single distinct resting area 150, scoring zone 750/850, wild card area 155, and/or wild card zone 755/855, for example as shown in FIG. 22B.

### Methods of Use

The game devices disclosed herein enable one or more players to play a card game without requiring a full deck of playing cards.

In one embodiment, a first player places a first golf ball in a origin spot 160/860 or a player action spot 760, then strikes the golf ball towards the distinct resting areas 750, the scoring zones 750/850, and the wild card areas 155/755/855. The player is awarded the playing card/wild card associated with the final resting spot of the first golf ball, as if the player had been dealt that playing card from a deck of playing cards. Thereafter, a second player places a second golf ball in a origin spot 160/860 or a player action spot 760, then strikes the golf ball towards the distinct resting areas 150, the scoring zones 750/850, and the wild card areas 155/755/855. The second player is awarded the playing card/wild card associated with the final resting spot of the second golf ball, as if that player had been dealt that playing card from a deck of playing cards. Play continues in this alternating manner until each player has been assigned the proper number of playing cards for the game of interest. For example, each player would continue play until he or she has been assigned five playing cards or wild cards if the game is a five-card poker variation such as five-card stud. Alternatively, each player would continue play until he or she has been assigned seven playing cards or wild cards if the game is a seven-card poker variation like seven-card stud. As in traditional poker games, betting rounds may occur before or after any series of player actions. In some embodiments, the final resting spot of the golf ball is determined by a single action (e.g., putt) of the player. In other embodiments, the final resting spot of the golf ball is determined by more than one action (e.g., putt) of the player, such as two actions, three actions, four actions, five actions, or more than five actions.

In some embodiments, a community poker game can be played using a game device 10/12/15/70/80/90 as disclosed herein. In such embodiments, a deck of cards or a processor 500 and associated display unit 650 may be used to assign the shared community cards. Thereafter, each player takes turns projecting a ball from a origin spot 160/860 or a player action spot 760 towards the distinct resting areas 150, the scoring zones 750/850, and the wild card areas 155/755/855, until each player has been assigned the proper number of cards. For example, to play Texas Hold 'Em, five cards would be assigned to the community, and each player would continue play until he or she is assigned two playing cards from the distinct resting areas 150, the scoring zones 750/850, and the wild card areas 155/755/855. Betting rounds may occur before or after any series of player actions, and the player with the highest five-card hand wins the round. In some embodiments, the deck of cards may include only those cards that are not represented by distinct resting areas 150 or scoring zones 750/850 to preserve the traditional ranking of poker hands (i.e., royal flush beats straight flush beats four of a kind beats full house beats flush beats straight beats three of a kind beats two pair beats pair beats high card). In embodiments wherein wild cards are assigned playing card suit and playing card rank values, one of skill in the art will recognize that poker hands that rank above a royal flush are possible. In some embodiments, the final resting spot of the ball (e.g., projectile) is determined by a single action (e.g., putt) of the player. In other embodiments, the final resting spot of the ball (e.g., projectile) is determined by more than one action (e.g., putt) of the player, such as two actions, three actions, four actions, five actions, or more than five actions.

Similarly, Omaha Hold 'Em may be played using a game device 10/12/15/70/80/90 as disclosed herein. In some embodiments, a deck of cards is used to assign five community cards, and players alternate turns projecting a ball from a origin spot 160/860 or a player action spot 760 towards the distinct resting areas 150, the scoring zones 750/850, and the wild card areas 155/755/855, until each player has been assigned four cards. In other embodiments, five balls are projected from a origin spot 160/860 or a player action spot 760 towards the distinct resting areas 150, the scoring zones 750/850, and the wild card areas 155/755/855 to assign the five community cards, instead of using a deck of cards as described above. The player then combines any two of his/her own playing cards with any three of the five community cards to build the highest scoring collection of five cards. In some embodiments, the deck of cards may include only those cards that are not represented by distinct resting areas 150 or scoring zones 750/850 to preserve the traditional ranking of poker hands (i.e., royal flush beats straight flush beats four of a kind beats full house beats flush beats straight beats three of a kind beats two pair beats pair beats high card). In some embodiments, the final resting spot of a projectile is determined by a single action (e.g., putt) of the player. In other embodiments, the final resting spot of a projectile is determined by more than one action (e.g., putt) of the player, such as two actions, three actions, four actions, five actions, or more than five actions.

Other card games may be played using the game systems described herein and following similar principles. For example, the game devices disclosed herein may also be used to play blackjack. In one embodiment, players (whether in the same location or connected via a network) take turns projecting a ball towards the scoring zones and wild card zones until one player delivers balls to scoring zones totaling 21, or until all players but one deliver balls to scoring zones totaling more than 21 (i.e., all but one player “busts”).

In any such method in which more than one origin spot 160/860 or player action area 760 is present, the method of playing the game may further comprise rolling a die before projecting the ball towards the distinct resting areas 150 or scoring zones 750/850 to determine which origin spot 160/860 or player action area 760 should be used by the player. In some embodiments, the origin spots 160/860 or player action areas 760 each have a distinct color, and the die comprises at least one side with each distinct color. In other embodiments, the origin spots 160/860 or player action areas 760 are each associated with a unique number, and the die comprises at least one side with each unique number.

Any method disclosed herein may further comprise enabling a player to block (e.g., “stymie”) one or more distinct resting area 150, the scoring zone 750/850, wild card area 155, and/or wild card zone 755/855. For example, in one embodiment, a player may earn a stymie action by propelling a projectile to rest on a wild card area 155 or wild card zone 755/855 that includes a “stymie” indicator, such as the stymie resting area shown in FIG. 16B. In some embodiments, the player is then permitted to place a stymie device, such as a stymie device 3000/3100/3200 shown in FIGS. 21A-21C, on one distinct resting area 150, scoring zone 750/850, wild card area 155, or wild card zone 755/855 of his or her choice, as shown representatively in FIG. 22A. In other embodiments, the player is permitted to place a stymie device, such as a stymie device 3000/3100/3200 shown in FIGS. 21A-21C, on more than one distinct resting area 150, scoring zone 750/850, wild card area 155, or wild card zone 755/855 of his or her choice, as shown representatively in FIG. 22B. In any such method played on a game system comprising one or more display units 400 and a processor 500 as described above, the processor may be used to (1) assign community cards, if required by the chosen card game, and display distinct resting areas representing only playing cards not included in the assigned community cards, and optionally (2) adjust the size of one or more distinct resting areas 150 and/or one or more wild card areas 155 to increase or decrease the odds that a player achieves a highly desirable hand.

In embodiments wherein the distinct resting areas 150 and wild card areas 155 are projected to the surface of the mat 100, such as embodiments shown in FIGS. 4-5, a physical stymie device 3000/3100/3200 may be used to physically block a projectile from coming to rest on a stymied distinct resting area 150 or wild card area 155, or any portion thereof. In other embodiments, a distinct resting area 150 or wild card area 155 may be stymied by de-projecting the desired distinct resting area 150 or wild card area 155, for example using the input device 600.

The present disclosure further provides an electronic game environment comprising a computer-rendered arrangement of distinct resting areas 150 /scoring zones 750/850. In some embodiments, the electronic game environment additionally comprises one or more wild card areas 155/wild card zones 755/855. In such electronic game environments, ridges or borders 190 may be present between the distinct resting areas 150/scoring zones 750/850, and/or the wild card areas 155/wild card zones 755/855 as computer-rendered barriers, rather than as physical barriers as described above with respect to physical embodiments. The relative sizes of the distinct resting areas 150, scoring zones 750/850, wild card areas 155, and/or wild card areas 755/855 may vary from player to player, from round to round, and/or from player action to player action depending on a number of factors including, for example, player handicap, desirability of the playing card or wild card represented by the distinct resting area 150, scoring zone 750/850, wild card area 155, and/or wild card area 755/855, distance from the projectile, slope of the playing surface, and proximity to other desirable distinct resting areas 150, scoring zones 750/850, wild card areas 155, and/or wild card areas 755/855. For example, if a player has already collected the 10 of spades, the jack of spades, the queen of spades and the king of spades, a distinct resting area 150 or scoring zone 750/850 representing the ace of spades (e.g., including a playing card rank indictor 180/780/880 representing an ace and a playing card suit indicator 170/770/870 representing spades) may be rendered to have a relatively smaller area than a distinct resting area 150 or scoring zone 750/850 representing the ace of diamonds (e.g., including a playing card rank indictor 180/780/880 representing an ace and a playing card suit indicator 170/770/870 representing diamonds).

The distinct resting areas 150/scoring zones 750/850 may each comprise computer rendered playing card suit indicators 170/770/870, which in some embodiments may include computer rendered raised borders 192. Each distinct resting area 150/scoring zones 750/850 may further each include a computer rendered playing card rank indicator 180/780/880, which in some embodiments may each include a computer rendered raised border 193.

The wild card area(s) 155/wild card zone(s) 755/855 may include a computer rendered wild card indicator 185/785/885, which in some embodiments may include computer rendered raised borders 194. As described above with respect to FIGS. 11A-16, wild card areas 155/wild card zones 755/855 may include one or more symbols 185a, 185b, etc., that represent game play instructions in some embodiments.

In any computer-rendered embodiment described herein, the raised border(s) 190/192/193/194 may be rendered to be in an initial flush (e.g., un-raised) state, and subsequently in a raised state after the rendered ball has slowed below a desired speed. In other embodiments, the raised border(s) 190/192/193/194 may be rendered to alternate between a flush (e.g., un-raised) state and a raised state periodically, such as every 1 second, every 2 seconds, every 3 seconds, every 4 seconds, every 5 seconds, etc.

Computer rendered embodiments disclosed herein may further comprise one or more computer rendered tee-off areas 160, such as computer rendered origin spots 160 as described with respect to FIGS. 1A-1B.

Computer rendered embodiments disclosed herein may be used with any suitable gaming system, such as a virtual golf environment using golf clubs (e.g., a golf putter), Nintendo Wii, Sony PlayStation, Microsoft Xbox, a personal computer, or a portable computing device (e.g., a cellular telephone). In some such embodiments, the gaming system may comprise a transponder for use by a player, a receiver for receiving a game play signal from the transponder, a projectile, a controller in operative communication with the receiver, and a screen in operative communication with the controller. The controller may be configured to render a projectile target area consistent with the game devices and target areas disclosed herein.

Game play using a computer rendered embodiment disclosed herein may comprise causing the controller to render an electronic game play environment comprising at least one distinct resting area 150/scoring zones 750/850 and optionally at least one wild card area 155/wild card zone 755/855. Thereafter, game play may comprise causing a game play signal to be generated using the transponder (e.g., a Wii remote control device), for example by swinging the transponder like a golf club, and rendering movement of the projectile in response to the generated transponder signal. The rendered movement comprises a final resting location for the rendered projectile, which in some instances of game play corresponds to a specific distinct resting area 150/scoring zones 750/850 or a specific rendered wild card area 155/wild card zone 755/855. The controller stores the playing card suit indicator 170/770/870 and the playing card rank indicator 180/780/880 associated with the specific distinct resting area 150/scoring zones 750/850 or, if the final resting location of the rendered projectile corresponds to a wild card area 155/wild card zone 755/855, the controller prompts the player to choose a combination of a playing card suit and rank to be stored in association with the player's round of game play. Rounds of game play then repeat for each player in the same manner until the appropriate number of rounds have been completed (e.g., four rounds of game play for Omaha Hold 'Em, five rounds of game play for 5-card draw poker, etc.). In embodiments wherein players have access to a set of community cards, the controller may assign the required number of community cards (e.g., five community cards for Texas Hold 'Em or Omaha Hold 'Em poker) before the controller prompts a player to generate a game play signal using the transponder.

In any electronic game play embodiment disclosed herein, a step of prompting a player to wager may precede or follow any round of game play. A wager may comprise electronic credits, points, government-issued currency, or digital currency (e.g., Bitcoin).

In any electronic game play embodiment disclosed herein, a step of selecting a origin spot 160 at random, for example using a randomizing function (e.g., an electronic die roll).

In any electronic game play embodiment disclosed herein, a step of blocking one or more distinct resting area 150, scoring zone 750/850, rendered wild card area 155 or wild card zone 755/855 may follow any round of game play. For example, if a player causes his or her rendered golf ball to come to rest on a rendered wild card area 155 or wild card zone 755/855 associated with a stymie action, the player may be prompted to select a rendered distinct resting area 150, rendered scoring zone 750/850, rendered wild card area 155 or rendered wild card zone 755/855 to block using an electronically rendered stymie device. The electronically rendered stymie device may resemble a physical stymie device, such as stymie devices 3000, 3100 or 3200 described herein. In some embodiments, the electronic game prompts the player to select a shape of stymie device base 3020 to be used. In any embodiment, the electronic game may be configured to alter an original path of a rendered golf ball if the original path intersects with a stymie device.

The modified path may be calculated as a function of the original path (e.g., direction, spin and speed), the angle at which the path intersects with the stymie device, and the edge contour of the base of the stymie device. In some embodiments, the modified path may be based on the stymie device being a passive object (i.e., no energy is added to a golf ball that collides with its base). In other embodiments, the modified path may further include an increased speed after collision with a stymie device, as if the stymie device has further propelled the golf ball in a direction away from the stymie device (e.g., similar to a spring-loaded pinball bumper accelerating a pinball upon contact).

In any electronic game play embodiment disclosed herein, an advertisement may be displayed before or after any round of game play.

In any electronic game play embodiment disclosed herein, a winning hand may be rewarded with a coupon or discount on good or services.

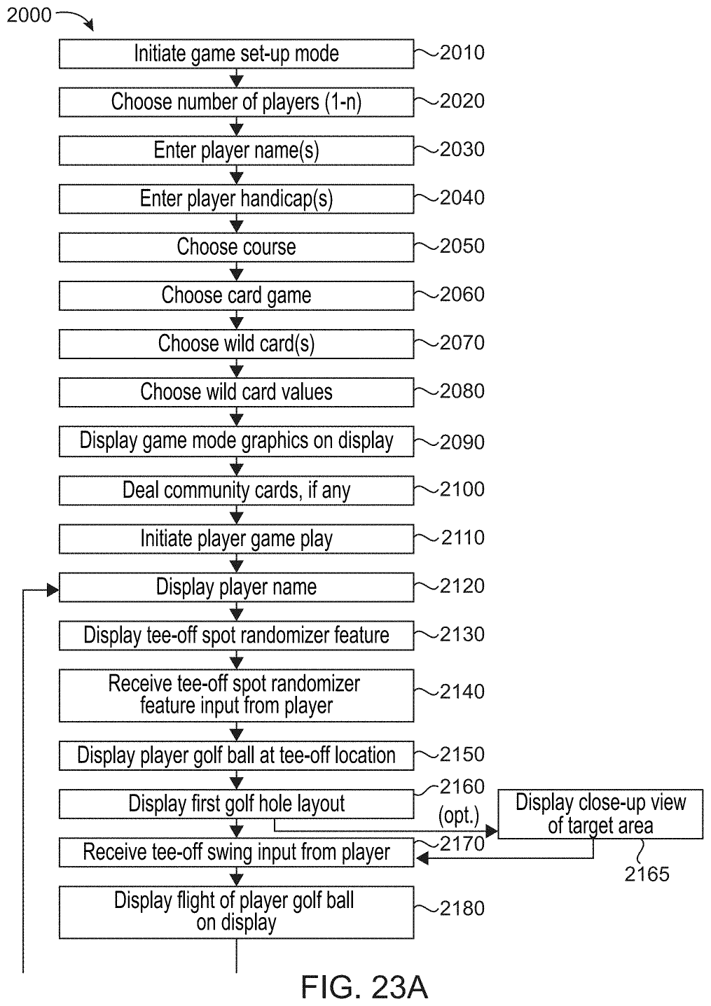

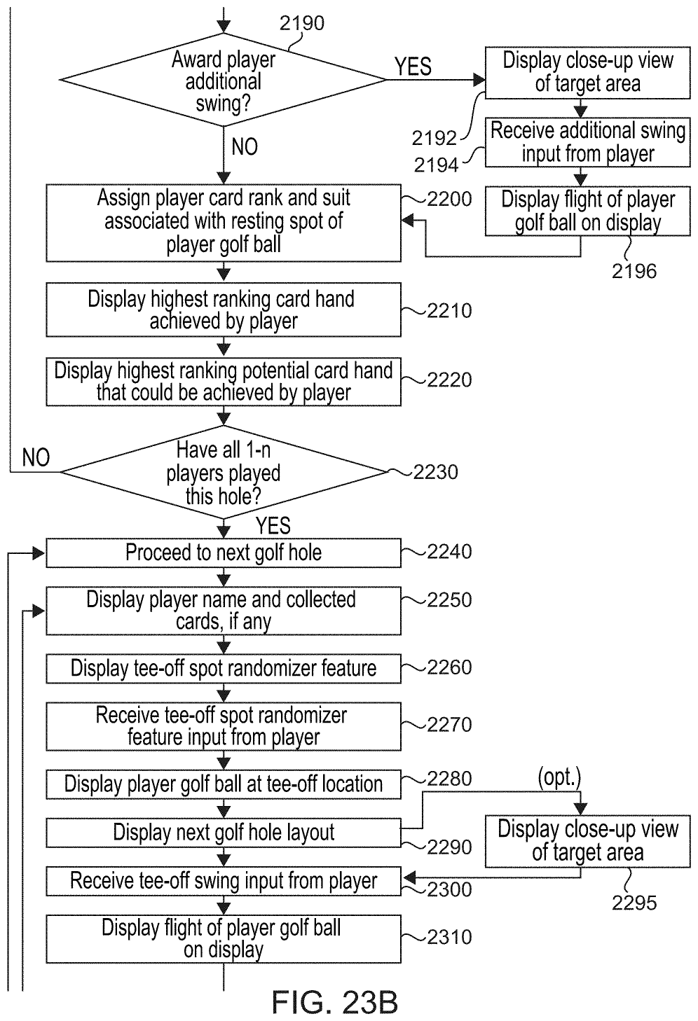

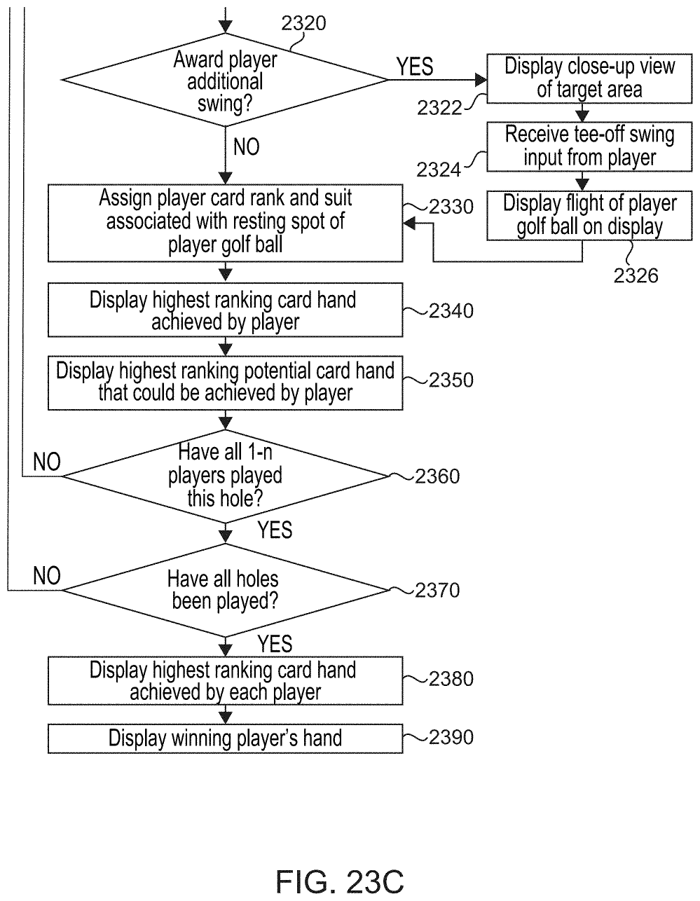

Referring now to FIGS. 23A-23C, a method 2000 for playing a card game using an electronically rendered golf course, for example using an electronic game machine 1800, comprises a step of initiating game set-up mode 2010. In some embodiments, the method 2000 further comprises a step 2020 of choosing a number of players, a step 2030 of entering player name(s), and optionally a step 2040 of entering player handicap values. The method 2000 may further comprise a step 2050 of choosing a golf course, which may be a fictional golf course, a computer-rendered approximation of a real golf course, or a mini golf style environment. The method 2000 may further comprise a step 2060 of choosing a card game to be played, such as a poker game, blackjack, etc. Rules of game play for the chosen card game may be stored in an electronic memory device, such as memory 1820 of the electronic game machine 1800 shown in FIG. 20. If the chosen card game includes wild card(s), the method 2000 may further comprise a step 2070 of selecting which card(s) are wild, and/or a step 2080 of assigning value(s) to wild card(s). The assigned value(s) may include an assigned playing card suit (e.g., any heart card), an assigned playing card color (e.g., any black card), an assigned playing card rank (e.g., an ace card of any suit), or a non-playing card game play instruction, such as awarding the player an additional game play, swapping one or more cards with another player, discarding one or more cards, etc.

Thereafter, the game play is initiated for example by displaying game mode graphics on a display as shown in step 2090. If the card game chosen in step 2060 includes community cards, the method 2000 may include a step 2100 of dealing the required number of community cards at random, which may be displayed on the display intermittently, on command, or throughout game play.

The first player then initiates game play as shown in step 2110. For example, in some embodiments the player's name is displayed as shown in step 2120. In some embodiments, the player tees off (e.g., takes his/her first golf swing) from a predetermined origin spot. The predetermined origin spot may, for example, be based at least in part on the player's handicap entered in step 2040. In other embodiments, the method 2000 comprises a step 2130 of displaying a origin spot randomizing feature, which determines the player's origin spot based on a system-generated randomizing function (e.g., a slot machine-style symbol generator), or alternatively based on origin spot randomizing input from the player as shown in step 2140. In some embodiments, the origin spot randomizing input from the player comprises a skill test (e.g., a practice putt), or an instruction to “stop” a spinner or sequence of random numbers generated by the electronic game machine.

The method 2000 then displays the player's golf ball at the determined or predetermined tee-off location in step 2150, displays the first golf hole layout in step 2160, and optionally displays a close-up view of the target area in step 2165. The target area includes distinct resting areas 150/scoring zones 750/850 rendered by the game machine and configured as described herein with respect to other disclosed embodiments.

The method 2000 further comprises receiving tee-off swing input from the player in step 2170. For example, the game machine may include an input device, such as input device 1830 shown in FIG. 20 and described above, which in some embodiments may be a remote transponder, a track pad, a roller ball, a computer mouse, a motion sensor, or a video capture device. In step 2180, the method 2000 comprises displaying the flight of the player's golf ball on a display in response to the tee-off swing input signal received in step 2170. The method 2000 may then award the player an additional swing in step 2190, such as if the flight of the player's golf ball terminates with the ball coming to rest on a wild card that has been assigned an extra swing reward in step 2080. If an additional swing is awarded to the player, the method 2000 may further comprise displaying a close-up view of the target area in step 2192, receiving an additional swing input from the player 2194, and displaying 2196 the flight of the player's golf ball in response to the additional swing input received in step 2194.

After all of the player's swing inputs have been received, and the player's turn ends, the method 2000 comprises assigning a card rank and suit to the player in step 2200. If the player earns a wild card, step 2200 may include prompting the player to choose a card rank and suit before the next player takes a turn. Alternatively, the method 2000 may only require the player to choose a card rank and suit for each earned wild card after all golf holes have been completed (e.g., after all cards have been earned). In some embodiments, the method 2000 further comprises displaying the highest ranking card hand achieved by the player so far in the game in step 2210 and/or displaying 2220 the highest ranking card hand that the player could potentially achieve based on the cards earned, any wild cards that have not yet been assigned a card rank and suit, and the number of cards yet to be earned by the player during play of subsequent golf holes. If all players in the game have played the first hole (step 2230), then play proceeds to the next golf hole in step 2240. Otherwise, the method 2000 comprises repeating steps 2120-2220 for each additional player in the game before proceeding to the next golf hole in step 2240.

Play of the next golf hole may proceed similarly to play of the first golf hole described above for steps 2120-2220. For example, play of the second golf hole may comprise displaying the player name and his/her earned cards in step 2250 before determining the player's tee-off location (steps 2260-2280) and displaying the second golf hole layout in step 2290 and optionally a close-up view of the target area 2295. after receiving swing input from the player in step 2300, the method 2000 comprises displaying the flight of the golf ball in step 2310, optionally awarding the player an additional swing (steps 2320-2326), assigning the player a card rank and suit based on the final resting location of the ball in relation to the target area (step 2330). The method 2000 may further include displaying the highest ranking card hand achieved by the player so far in the game in step 2340 and/or displaying 2350 the highest ranking card hand that the player could potentially achieve based on the cards earned, any wild cards that have not yet been assigned a card rank and suit, and the number of cards yet to be earned by the player during play of subsequent golf holes. If additional players have not yet played the second hole, then the method 2000 repeats steps 2120-2360 for each additional player registered in the game. If all players in the game have played the second hole (step 2360), and all golf holes have not yet been played (step 2370), then play proceeds to the next golf hole by repeating steps 2120-2360. Once all golf holes have been played by all players (step 2370), the method 2000 declares a winner by, for example, displaying the highest ranking card hand achieved by each of the registered players in step 2380 and displaying the winning player's hand and identity in step 2390.

The method 2000 may further comprise prompting all registered players to wager on the outcome of the card game before or after any round of game play (e.g., immediately before or after any one or more of steps 2080, 2100, 2110, 2170, 2360, or 2370). In some embodiments, the method 2000 further comprises allowing a player to purchase additional swings at step 2190 and/or step 2320 using virtual winnings (e.g., credits or points earned through game play) or using currency or virtual currency paid by coin, bill, credit card, debit card, electronic funds transfer, or bitcoin. Winnings earned by a player may be paid out in game play credits, loyalty points, handicap adjustments, coins, bills, electronic funds transfer, or bitcoin.

Accordingly, a method of playing a card game consistent with the present disclosure comprises causing a first golf ball to come to rest in a first resting area of a scoring zone of a game apparatus, wherein the first resting area corresponds to a first combination of a playing card suit and a playing card rank; causing a second golf ball to come to rest in a second resting area of a scoring zone of the game apparatus, wherein the second resting area corresponds to a second combination of a playing card suit and a playing card rank; causing a third golf ball to come to rest in a third resting area of a scoring zone of the game apparatus, wherein the third resting area corresponds to a third combination of a playing card suit and a playing card rank; causing a fourth golf ball to come to rest in a fourth resting area of a scoring zone of the game apparatus, wherein the fourth resting area corresponds to a fourth combination of a playing card suit and a playing card rank; and causing a fifth golf ball to come to rest in a fifth resting area of a scoring zone of the game apparatus, wherein the fifth resting area corresponds to a fifth combination of a playing card suit and a playing card rank. In some embodiments, the game apparatus is a device substantially as disclosed herein.

In other embodiments, a method of playing poker according to the present disclosure comprises (a) enabling a first player to cause a first ball to come to rest in a first scoring zone of a poker game apparatus, the first scoring zone representing a first combination of a playing card suit and a playing card rank; (b) enabling a second player to cause a second ball to come to rest in a second scoring zone of the poker game apparatus, the second scoring zone representing a second combination of a playing card suit and a playing card rank; (c) enabling the first player to cause a third ball to come to rest in a third scoring zone of the poker game apparatus, the third scoring zone representing a third combination of a playing card suit and a playing card rank; (d) enabling the second player to cause a fourth ball to come to rest in a fourth scoring zone of the poker game apparatus, the fourth scoring zone representing a fourth combination of a playing card suit and a playing card rank; (e) enabling the first player to cause a fifth ball to come to rest in a fifth scoring zone of the poker game apparatus, the fifth scoring zone representing a fifth combination of a playing card suit and a playing card rank; (f) enabling the second player to cause a sixth ball to come to rest in a sixth scoring zone of the poker game apparatus, the sixth scoring zone representing a sixth combination of a playing card suit and a playing card rank; (g) enabling the first player to cause a seventh ball to come to rest in a seventh scoring zone of the poker game apparatus, the seventh scoring zone representing a seventh combination of a playing card suit and a playing card rank; (h) enabling the second player to cause an eighth ball to come to rest in an eighth scoring zone of the poker game apparatus, the eighth scoring zone representing an eighth combination of a playing card suit and a playing card rank; (i) enabling the first player to cause a ninth ball to come to rest in a ninth scoring zone of the poker game apparatus, the ninth scoring zone representing a ninth combination of a playing card suit and a playing card rank; and (k) enabling the second player to cause a tenth ball to come to rest in a tenth scoring zone of the poker game apparatus, the tenth scoring zone representing a tenth combination of a playing card suit and a playing card rank. In some embodiments, the game apparatus is a device substantially as disclosed herein.

A method of improving a sports technique of a user, the method comprising: (a) placing a first ball near one of a plurality of origin spots on a top side of a sports training device described herein; (b) causing the first ball to travel generally along the top side from the origin spot towards the plurality of distinct resting areas on the top side and near the distal end; (c) recording a scoring value associated with a distinct resting area on which the first ball comes to rest; (d) repeating steps (a)-(c) with a second ball; (e) repeating steps (a)-(c) with a third ball; (f) optionally repeating steps (a)-(c) with a fourth ball; and (g) optionally repeating steps (a)-(c) with a fifth ball, wherein the distinct resting area in at least one of steps (d), (e), (f), and (g) is a distinct resting area preselected by the user based at least in part on the distinct resting area on which a previous ball has come to rest. In some embodiments, the distinct resting areas each comprise a playing card suit indicator and a playing card rank indicator, represents a wild card, or represents a player action instruction. In some embodiments, each of the distinct resting areas comprising a playing card suit indicator and a playing card rank indicator represents a unique combination of a playing card suit indicator and a playing card rank indicator. In some embodiments, the method further comprises: (h) compiling a user score based on a combination of scoring values associated with the distinct resting areas on which the balls come to rest. In some embodiments, the method further comprises: (i) comparing the user score in step (h) with a score of a second user after the second user performs steps (a)-(h). In some embodiments, the user score compiled in step (h) is based at least in part on a hierarchy associated with a card game. In some embodiments, the sports training apparatus comprises: a mat comprising a proximal end, a distal end, a top side and a bottom side; a plurality of distinct resting areas on the top side and near the distal end; a raised ridge on the top side between each of the distinct resting areas; and at least one origin spot on the top side and near the proximal end for placing a ball. In some embodiments, the distinct resting areas each comprise a playing card suit indicator and a playing card rank indicator, represents a wild card, or represents a player action instruction. In some embodiments, each of the distinct resting areas comprising a playing card suit indicator and a playing card rank indicator represents a unique combination of a playing card suit indicator and a playing card rank indicator. In some embodiments, the sports training apparatus comprises at least 13 distinct resting areas. In some embodiments, the sports training apparatus comprises at least 26 distinct resting areas. In some embodiments, the sports training apparatus comprises 52 distinct resting areas. In some embodiments, the sports training apparatus comprises 56 distinct resting areas.

In some embodiments, the sports training apparatus comprises 64 distinct resting areas. In some embodiments, the sports training apparatus comprises at least two origin spots. In some embodiments, the sports training apparatus comprises at least three origin spots. In some embodiments, the sports training apparatus further comprises a slope extending from at or near the proximal end upwards towards the distal end. In some embodiments, the sports training apparatus further comprises a slope extending from at or near the proximal end downwards towards the distal end. In some embodiments, the proximal end is at a lower elevation than the distal end. In some embodiments, the raised ridge comprises a continuous ridge. In some embodiments, the raised ridge comprises a plurality of raised ridge segments. In some embodiments, each of the ridge segments has a circular topographical shape. In some embodiments, each of the ridge segments has an oblong topographical shape. In some embodiments, the top side has a surface stimp rating of about 7 to about 14, such as about 7, about 8, about 9, about 10, about 11, about 12, about 13, or about 14. In some embodiments, the top side has a surface stimp rating of about 11. In some embodiments, the sports training apparatus is flexible.

In some embodiments, less than about 1% of the raised ridges dissociate from the golf apparatus when the sports training apparatus is rolled into a cylindrical shape. In some embodiments, at least one of the distinct resting areas represents a wild card. In some embodiments, the raised ridge protrudes from the top side of the sports training apparatus by at least about 0.15 mm and by not more than about 0.6 mm, such as at least about 0.15 mm, at least about 0.16 mm, at least about 0.17 mm, at least about 0.18 mm, at least about 0.19 mm, at least about 0.2 mm, at least about 0.21 mm, at least about 0.22 mm, at least about 0.23 mm, at least about 0.24 mm, at least about 0.25 mm, at least about 0.26 mm, at least about 0.27 mm, at least about 0.28 mm, at least about 0.29 mm, at least about 0.3 mm, at least about 0.31 mm, at least about 0.32 mm, at least about 0.33 mm, at least about 0.34 mm, at least about 0.35 mm, at least about 0.36 mm, at least about 0.37 mm, at least about 0.38 mm, at least about 0.39 mm, at least about 0.4 mm, at least about 0.41 mm, at least about 0.42 mm, at least about 0.43 mm, at least about 0.44 mm, at least about 0.45 mm, at least about 0.46 mm, at least about 0.47 mm, at least about 0.48 mm, at least about 0.49 mm, at least about 0.5 mm, at least about 0.51 mm, at least about 0.52 mm, at least about 0.53 mm, at least about 0.54 mm, at least about 0.55 mm, at least about 0.56 mm, at least about 0.57 mm, at least about 0.58 mm, at least about 0.59 mm, or at least about 0.6 mm. In some embodiments, each ridge segment protrudes from the top side of the sports training apparatus by at least about 0.15 mm and by not more than about 0.6 mm, and wherein each ridge segment has a diameter of at least about 1 mm and not more than about 4 mm, for example about 1 mm, about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, about 3.6 mm, about 3.7 mm, about 3.8 mm, about 3.9 mm, or about 4 mm. In some embodiments, each ridge segment protrudes from the top side of the sports training apparatus by about 0.4 mm and has a diameter of about 2.5 mm. In some embodiments, the sports training apparatus comprises a graphic element on the top side between the at least one origin spot and the plurality of distinct resting areas near the distal end. In some embodiments, the ball is a golf ball.

### Methods of Making

Embodiments of the present disclosure that include a golf putting surface can be generally produced by applying one or more distinct resting areas 150//750 to the top surface 130/730 of the mat 100/700, applying the one or more origin spots 160/760 to the top surface 130/730 near the proximal end 110/710 of the mat 100/700, and applying the raised ridge 190/790 to the top surface 130/730 of the mat 100/700.

In some embodiments, the step of applying the one or more distinct resting areas 150/750 comprises printing the one or more distinct resting areas 150/750 with ink (e.g., UV-curable ink) to the top surface 130/730 of the mat 100/700 (e.g., a carpet) and, if required, curing the ink, for example with heat and/or a UV light source. In some embodiments, the step of applying the one or more distinct resting areas 150/750 is accomplished using a UV-LED printer (Sun 3D Corporation, Pompano Beach, Fla.) applying nano UV inks (Sun 3D Corporation, Pompano Beach, Fla.) to the top surface 130/730 of the carpet mat 100/700. In some embodiments, the step of applying the one or more distinct resting areas 150/750 further comprises applying one or more reference marks (e.g., a datum) to the top surface 130/730 of the mat 100/700.

In some embodiments, the step of applying the one or more origin spots 160/760 to the top surface 130/730 near the proximal end 110/710 of the mat 100/700 comprises printing the one or more origin spots 160/760 with ink (e.g., UV-curable ink) to the top surface 130/730 of the mat 100/700 (e.g., a carpet) and, if required, curing the ink, for example with heat and/or a UV light source. In some embodiments, the step of applying the one or more origin spots 160/760 is accomplished using a UV-LED printer (Sun 3D Corporation, Pompano Beach, Fla.) applying nano UV inks (Sun 3D Corporation, Pompano Beach, Fla.) to the top surface 130/730 of the carpet mat 100/700.

In some embodiments, the step of applying the raised ridge 190/790 to the top surface 130/730 of the mat 100/700 comprises applying elastomer to the top surface 130/730 of the mat 100/700 around each resting area 150/750. In some embodiments, the step of applying the raised ridge 190/790 further comprises curing the elastomer, for example using heat and/or a light source (e.g., a UV lamp). In some embodiments, the elastomer is applied manually. In other embodiments, the elastomer is applied by an automated process, which may begin by aligning an elastomer applicator device to the one or more distinct resting areas 150/750, and thereafter applying the elastomer to the top surface 130/730 of the mat 100/700 using the elastomer applicator device. In some embodiments, the step of aligning the elastomer applicator comprises aligning the elastomer applicator device to one or more orientation reference marks (e.g., one or more registration marks, crop marks, datum/data, crosshairs, etc.) previously applied to the top surface 130/730. In some embodiments, the elastomer applicator device is a template. In other embodiments, the elastomer applicator device comprises a 2-axis or 3-axis gantry associated with an elastomer dispenser.

Applying the raised ridges 190/790 may be accomplished, in some embodiments, by first applying the distinct resting areas 150/scoring zone 750 to the surface 130/730 of a mat 100/700. For example, in some embodiments, the elastomer or plastic material comprising the raised ridged 190/790 is applied to the surface 130/730 of the mat 100/700 using an x/y format material applicator (e.g., a 3D printer). In some embodiments, the x/y format material applicator includes a nozzle that deposits a desired amount of a heated filament to the surface 130/730 of the mat 100/700 at each desired location, such as between each distinct resting area 150/scoring zone 750 and around the perimeter of the collection of the distinct resting areas 150/scoring zones 750. In some embodiments, the x/y format material applicator deposits an amount of the heated filament to the surface 130/730 to form a raised ridge 190/790 and/or a plurality of raised ridge segments 190a/790a that protrudes from the surface 130/730 of the mat 100/700 by at least about 0.15 mm and by not more than about 0.6 mm, such as at least about 0.15 mm, at least about 0.16 mm, at least about 0.17 mm, at least about 0.18 mm, at least about 0.19 mm, at least about 0.2 mm, at least about 0.21 mm, at least about 0.22 mm, at least about 0.23 mm, at least about 0.24 mm, at least about 0.25 mm, at least about 0.26 mm, at least about 0.27 mm, at least about 0.28 mm, at least about 0.29 mm, at least about 0.3 mm, at least about 0.31 mm, at least about 0.32 mm, at least about 0.33 mm, at least about 0.34 mm, at least about 0.35 mm, at least about 0.36 mm, at least about 0.37 mm, at least about 0.38 mm, at least about 0.39 mm, at least about 0.4 mm, at least about 0.41 mm, at least about 0.42 mm, at least about 0.43 mm, at least about 0.44 mm, at least about 0.45 mm, at least about 0.46 mm, at least about 0.47 mm, at least about 0.48 mm, at least about 0.49 mm, at least about 0.5 mm, at least about 0.51 mm, at least about 0.52 mm, at least about 0.53 mm, at least about 0.54 mm, at least about 0.55 mm, at least about 0.56 mm, at least about 0.57 mm, at least about 0.58 mm, at least about 0.59 mm, or at least about 0.6 mm. In some embodiments, the x/y format material applicator deposits more than one layer of the heated filament to the surface 130/730 of the mat 100/700 to build up the raised ridges 190/790 and/or the raised ridge segments 190a/790a to the desired height.

In some embodiments, the method of applying the raised ridges 190/raised ridge segments 190a/790a further comprises allowing the heated filament to cure (e.g., cool) before using the mat 100/700 or rolling the mat 100/700 for storage.

In some embodiments, the method additionally comprises aligning the mat 100/700 in an x/y dimension to the x/y format material applicator. In some embodiments, the step of aligning comprises placing the mat 100/700 in a jig or frame associated in a fixed x/y orientation to the x/y format material applicator. In such embodiments, the x/y format material applicator may be programmed to apply the heated filament to the surface 130/730 of the mat 100/700 following a predetermined x/y grid based at least on the relative arrangement of the x/y format material applicator's nozzle to the jig or frame. In other embodiments, the step of aligning comprises placing the mat 100/700 under the nozzle of an x/y format material applicator, and thereafter causing the x/y format material applicator to determine the x/y orientation of the mat 100/700 (e.g., the x/y orientation of the distinct resting areas 150/scoring zones 750) relative to the x/y orientation of the x/y format material applicator. In such embodiments, the surface 130/730 of the mat 100/700 may include one or more orientation reference markers (e.g., one or more registration marks, crop marks, datum/data, crosshairs, etc.) that are scanned by the x/y format material applicator before its nozzle begins to deposit heated filament to the surface 130/730 of the mat 100/700. In some embodiments, the x/y format material applicator causes the mat 100/700 to be moved to a desired orientation based at least in part on information associated with the x/y orientation of the scanned orientation reference marks. In other embodiments, the x/y format material applicator adjusts a preprogrammed x/y deposition grid plan based at least in part on information associated with the x/y orientation of the scanned orientation reference marks, but does not move the mat 100/700 relative to the nozzle.

In some embodiments, the filament deposited by the x/y format material applicator is a thermoplastic polyurethane (“TPU”) filament having a hardness (ASTM D2240) of Shore D 33 (Shore A 85), a specific gravity (ASTM D792) of about 1.19 g/cc, a yield tensile strength (ASTM D638) of about 580 psi, an ultimate tensile strength (ASTM D638) of about 3,700 psi, a tensile modulus (ASTM D638) of about 1,800 psi, an elongation at yield value (ASTM D638) of about 65%, an elongation at break value (ASTM D638) of about 660%, a toughness value (ASTM D638) of about 12,000 in·lbF/in³, an impact strength value (ASTM D256; notched Izod, 23° C.) of about 2.0 ft·lbf/int², and an abrasion resistance value (ASTM D4060; mass loss at 10,000 cycles) of about 0.08 g (e.g., NINJAFLEX 3D Printing Filament, Fenner Drives/Fenner Inc., Manheim, Pa.).

In some embodiments, the filament deposited by the x/y format material applicator is a polymer-based thermoplastic elastomer (“TPEE”) filament having a hardness of Shore D 40 (Shore A 91), a specific gravity of about 1.07-1.27 g/cc, a tensile strength of about 220-500, an elongation value of about 320-900 (e.g., MAKER FLEX 3D Filament, Maker Geeks Manufacturing, Inc., Springfield, Mo.).

In some embodiments, the filament deposited by the x/y format material applicator is a polyamide (nylon) filament (e.g., “Pro Series Nylon”)

In some embodiments, and in particular embodiments wherein the raised ridges 190/790 comprise a plurality of raised ridge segments 190a/790a separated by spaces 190b/790b, the filament deposited by the x/y format material applicator may be a relatively inflexible material, such as acrylonitrile butadiene styrene (“ABS”), polylactic acid (“PLA”), co-polyester (“nGen”, Eastman Amphora AM2200 3D polymer), polyamide with chopped carbon fiber strands (“NylonX”), a polyethylene-based material (PETG or PETT), or acrylonitrile styrene acrylate (“ASA”).

In other embodiments, the raised ridges 190/790 and/or the raised ridge segments 190a/790a are applied manually by depositing (e.g., by hand-depositing) the raised ridges 190/790 to the surface 130/730 of the mat 100/700. In some embodiments, the raised ridges 190/790 and/or the raised ridge segments 190a/790a are applied manually after the distinct resting areas 150/750 are applied to the surface 130/730 of the mat 100/700. In other embodiments, the raised ridges 190/790 and/or the raised ridge segments 190a/790a are applied manually before the distinct resting areas 150/750 are applied to the surface 130/730 of the mat 100/700, and the distinct resting areas 150750 are thereafter applied to the surface 130/730 of the mat 100/700, for example by applying ink to the surface 130/730 as described herein.

In some embodiments, the relative arrangement of the one or more resting areas 150/750 featured on a first gaming system 10/12/20/70 is different than the relative arrangement of the one or more resting areas 150/750 featured on a second gaming system 10/12/20/70.

### EXAMPLES

### Example 1. Golf Training Apparatus

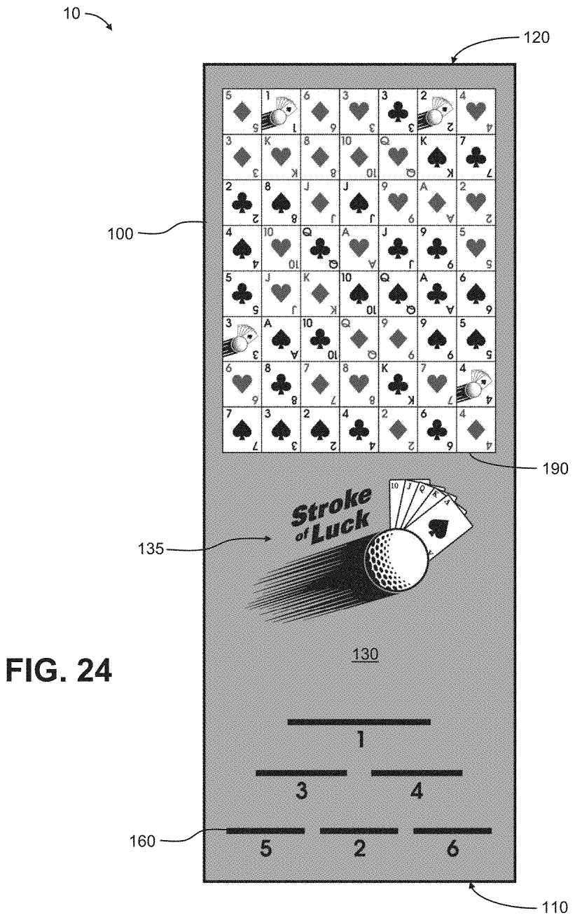

The game system 10 shown in FIG. 24 is prepared by printing the resting areas 150 and origin spots 160 using UV-curable ink and a UV-LED printer (Sun 3D Corporation, Pompano Beach, Fla.) onto a mat 100 that is a Premium Carpet Logo Mat (American Floor Mats; Rockville, Md.) featuring a nitrile rubber backing and a surface including 26 oz/yd², ⅜-inch height cut pile DuPont's Solution Dyed Continuous Filament 6,6 Nylon with outstanding lightfastness and 6 twist turns per inch (heat set). After the UV-curable ink cures, the raised ridges 190 are applied to the surface 130 of the mat 100 by hand-depositing elastomeric material to the surface 130 of the mat 100 around and between each distinct resting area 150.

The game system 10 of this Example 1 has a stimp rating of about 11.

1. A sports training apparatus comprising:
a mat comprising a proximal end, a distal end, a top side and a bottom side;
a plurality of distinct resting areas on the top side and near the distal end;
at least one origin spot on the top side and near the proximal end for placing a ball.

2. The sports training apparatus of claim 1, wherein the distinct resting areas each comprise a playing card suit indicator and a playing card rank indicator, represents a wild card, or represents a player action instruction.

3. The sports training apparatus of claim 2, wherein each of the distinct resting areas comprising a playing card suit indicator and a playing card rank indicator represents a unique combination of a playing card suit indicator and a playing card rank indicator.

4. The sports training apparatus of claim 1 comprising at least 13 distinct resting areas.

5-6. (canceled)

7. The sports training apparatus of claim 1 comprising at least two origin spots.

8-15. (canceled)

16. The sports training apparatus of claim 1, wherein the top side has a surface stimp rating of about 7 to about 14.

17. The sports training apparatus of claim 1, wherein the sports training apparatus is flexible.

18. (canceled)

19. The sports training apparatus of claim 1, wherein at least one of the distinct resting areas represents a wild card.

20-21. (canceled)

22. The sports training apparatus of claim 1, further comprising a graphic element on the top side between the at least one origin spot and the plurality of distinct resting areas near the distal end.

23. The sports training apparatus of claim 1, wherein the ball is a golf ball.

24. A method of improving a sports technique of a user, the method comprising:
(a) placing a first ball near one of a plurality of origin spots on a top side of a sports training device of claim 1;
(b) causing the first ball to travel generally along the top side from the origin spot towards the plurality of distinct resting areas on the top side and near the distal end;
(c) recording a scoring value associated with a distinct resting area on which the first ball comes to rest;
(d) repeating steps (a)-(c) with a second ball;
(e) repeating steps (a)-(c) with a third ball;
(f) optionally repeating steps (a)-(c) with a fourth ball; and
(g) optionally repeating steps (a)-(c) with a fifth ball,
wherein the distinct resting area in at least one of steps (d), (e), (f), and (g) is a distinct resting area preselected by the user based at least in part on the distinct resting area on which a previous ball has come to rest.

25-26. (canceled)

27. The method of claim 24 further comprising:
(h) compiling a user score based on a combination of scoring values associated with the distinct resting areas on which the balls come to rest.

28. The method of claim 27 further comprising:
(i) comparing the user score in step (h) with a score of a second user after the second user performs steps (a)-(h).

29. The method of claim 27, wherein the user score compiled in step (h) is based at least in part on a hierarchy associated with a card game.

30. The method of claim 29, wherein the card game is a poker game.
